(19) United States
(12) Patent Application Publication
(10) Pub. No.: US 2026/0371409 A1
(43) Pub. Date: Nov. 19, 2026

(54) SYSTEMS AND METHODS FOR TRANSMISSION AND RECEPTION OF POSITIONING REFERENCE SIGNAL IN NEW RADIO (NR) UNLICENSED BAND

(71) Applicant: ZTE CORPORATION, Shenzhen, Guangdong (CN)

(72) Inventors: Qi YANG, Shenzhen (CN); Chuangxin JIANG, Shenzhen (CN); Mengzhen LI, Shenzhen (CN); Yu PAN, Shenzhen (CN); Zhiqiang HAN, Shenzhen (CN); Junpeng LOU, Shenzhen (CN); Cong WANG, Shenzhen (CN)

(21) Appl. No.: 19/130,968

(22) PCT Filed: Jul. 31, 2023
(86) PCT No.: PCT/CN2023/110384

§ 371 Date: May 19, 2025

(51) Int. Cl. H04W 74/08; H04L 5/00

(52) U.S. Cl. CPC H04W 74/0875; H04L 5/0051

(57) ABSTRACT

Presented are systems and methods for transmission and reception of positioning reference signal in a new radio (NR) unlicensed band. A first wireless communication entity may send a positioning reference signal on an unlicensed band based on one or more channel occupancy parameters associated with the unlicensed band to a second wireless communication entity.

### TECHNICAL FIELD

The disclosure relates generally to wireless communications, including but not limited to systems and methods for transmission and reception of positioning reference signal in a new radio (NR) unlicensed band.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A first wireless communication entity may send a positioning reference signal on an unlicensed band based on one or more channel occupancy parameters associated with the unlicensed band to a second wireless communication entity. The first wireless communication entity may identify the one or more channel occupancy parameters based on reusing a Channel Access Priority Class (CAPC) table configured for data transmission.

In some embodiments, the first wireless communication entity may identify the one or more channel occupancy parameters based on a preconfigured CAPC table. A configuration of the preconfigured CAPC table is associated with a configuration of the positioning reference signal. The one or more channel occupancy parameters may include at least one of: a CAPC value, a minimum contention window size, a maximum contention window size, an allowed contention window size, or a maximum Channel Occupancy Time (COT).

In some embodiments, the configuration of the positioning reference signal, which is a DL-PRS, may include at least one of: a priority of the DL-PRS, a duration of transmission of the DL-PRS, a repetition factor of the DL-PRS, a time gap between two repetitions of the DL-PRS, or a period of the DL-PRS. The configuration of the positioning reference signal, which is an UL-SRS, may include at least one of: a priority of the UL-SRS, a duration of transmission of the UL-SRS, a number of symbols of the UL-SRS, or a period of the UL-SRS.

In some embodiments, the CAPC value can indicated by an Information Element (IE) explicitly. The CAPC value can be determined based on the configuration of the positioning reference signal. The CAPC value for sending the positioning reference signal, which is a DL-PRS, can be configured by a core network entity or a higher layer of the first wireless communication entity. The CAPC value for sending the positioning reference signal, which is a UL-SRS, can be configured by the core network entity or the higher layer of the first wireless communication entity or a higher layer of the second wireless communication entity.

In some embodiments, the CAPC value for sending the positioning reference signal, which is a DL-PRS, can be configured per Physical Frequency Layer (PFL), per DL-PRS resource set, or per DL-PRS resource. The CAPC value for sending the positioning reference signal, which is a UL-SRS, can be configured per Bandwidth Part (BWP), per UL-SRS resource set, or per UL-SRS resource, wherein the second wireless communication entity is in an RRC_CONNECTED state. The CAPC value for sending the positioning reference signal, which is a UL-SRS, can be configured per UL-SRS resource set or per UL-SRS resource, and wherein the second wireless communication entity is in an RRC_INACTIVE state.

In some embodiments, the first wireless communication entity may initiate a channel occupancy procedure using a Type 2A channel access procedure, upon at least one of the following conditions being satisfied: (a) a transmission duration of a DL-PRS is at most 1 ms and a transmission duty cycle of the DL-PRS is at most 1/20; (b) a CAPC value configured for the DL-PRS is less than or equal to a CAPC threshold; (c) a priority value configured for the DL-PRS is less than a priority threshold; or (d) transmission of the DL-PRS is broadcasted. The first wireless communication entity may send the positioning reference signal in a shared channel occupancy procedure, upon the following condition being satisfied: a CAPC value configured for the positioning reference signal is less than or equal to a CAPC value initiating the shared channel occupancy procedure.

In some embodiments, a period of the positioning reference signal can be associated with a period of a semi-static channel occupancy procedure. The association may include at least one of: the period of the positioning reference signal can be equal to the period of the semi-static channel occupancy procedure, or the period of the positioning reference signal can be an integer multiple of the period of semi-static occupancy procedure. A configuration of a semi-static channel occupancy procedure for the positioning reference signal may not be limited to a number of radio frames. The configuration of the semi-static channel occupancy procedure may include at least one of: a period of the semi-static channel occupancy procedure, or a time offset of the period of the semi-static channel occupancy procedure relative to a reference time.

In some embodiments, the first wireless communication entity may report information about a semi-static channel occupancy procedure initiated by the first wireless communication entity to a core network entity. The information may include at least one of: a period of the semi-static channel occupancy procedure, a time of idle duration, or a COT length. The first wireless communication entity may receive a message that includes a recommendation, from the core network entity, of a transmission resource of the positioning reference signal, which is a DL-PRS. The core network entity may recommend a transmission resource of the positioning reference signal, which is a DL-PRS, to the first wireless communication entity. The core network entity may recommend a transmission resource of the positioning reference signal, which is an UL-SRS, to a serving base station. The transmission resource of the positioning reference signal recommended to the first wireless communication entity and the transmission resource of the positioning reference signal recommended to a serving base station can be the same or different.

In some embodiments, in response to determining that a time-domain resource configured for the positioning reference signal is within a COT, the first wireless communication entity may send the positioning reference signal. In response to determining that a time-domain resource configured for the positioning reference signal is not within a COT, the first wireless communication entity may stop sending the positioning reference signal.

In some embodiments, the first wireless communication entity may send the positioning reference signal based on some rules, if only partial symbols of configured for the positioning reference signal are within a COT. The first wireless communication entity may send channel occupancy window related information related to the positioning reference signal to a third wireless communication entity. The first wireless communication entity or the second wireless communication entity may be previously initiated a COT for the positioning reference signal. If the COT is initiated based on a dynamic channel access procedure, the channel occupancy window related information may include at least one of: a CAPC value initiating the COT, a duration of the COT, a start time of the COT, a length of a channel occupancy window, or a start time of the channel occupancy window.

In some embodiments, if the COT is initiated based on a semi-static channel occupancy, the channel occupancy window related information may include at least one of: a period of the semi-static channel occupancy, a maximum COT of a period of semi-static channel occupancy, a start time of a period of semi-static channel occupancy, a length of a channel occupancy window, or a start time of the channel occupancy window. The length of the channel occupancy window may not be larger than the maximum COT. The length of the channel occupancy window may not be larger than the maximum COT of a period of the semi-static channel occupancy. The third wireless communication entity can be determined by the first wireless communication entity or the second wireless communication entity or the core network entity.

In some embodiments, a PFL configured for sending the positioning reference signal may include an integer number of Resource Block (RB) sets. The first wireless communication entity may perform a channel access procedure per RB set. A guard band can be configured or not configured between two continuous RB sets. An indicator of multiple-channel access procedure type can be included in a configuration of the PFL, or a configuration of a positioning service, or a configuration of a positioning reference signal resource set, or a configuration of a positioning reference signal resource.

In some embodiments, one or more transmission gaps, configured for sending the positioning reference signal, which is a DL-PRS, can be configured by a higher layer of the first wireless communication entity. One or more transmission gaps, configured for sending the positioning reference signal, which is an UL-SRS, can be configured by a core network entity, a higher layer of the first wireless communication entity, or a higher layer of the second wireless communication entity. The one or more transmission gaps can be each associated with a transmission gap ID. A configuration of the one or more transmission gaps may include at least one of: a transmission gap ID, a length of the one or more transmission gaps, a period of the one or more transmission gaps, a reference point in a time domain, or an offset of the one or more transmission gaps relative to the reference point in the time domain.

In some embodiments, the first wireless communication entity may perform a channel access procedure before each positioning reference signal resource transmission in a transmission gap. If the positioning reference signal is a DL-PRS, multiple candidate COTs for sending the positioning reference signal can be configured by a higher layer of the first wireless communication entity in a transmission gap. If the positioning reference signal is an UL-SRS, multiple candidate COTs for sending the positioning reference signal can be configured by a core network entity, or a higher layer of the first wireless communication entity, or a higher layer of a serving base station in a transmission gap. A configuration of the transmission gap further may include number of candidate COTs and the configuration of the candidate COTs. The candidate COTs in the transmission gap can be periodic or aperiodic. If the candidate COTs are periodic, a configuration of one of the candidate COTs may include at least one of: an ID of the candidate COT, a length of the candidate COT, a period of the candidate COT, or an offset of the candidate COT relative to a start time of the transmission gap. If the candidate COTs are aperiodic, a configuration of one of the candidate COTs may include at least one of: an ID of the candidate COT, a length of the candidate COT, or an offset of the candidate COT relative to a start time of the transmission gap. The candidate COTs in the transmission gap for sending the positioning reference signal, which is a DL-PRS, can be configured per transmission gap, or per PFL, or per serving cell, or per UE. The candidate COTs in the transmission gap for sending the positioning reference signal, which is an UL-SRS, can be configured per transmission gap, or per UE, or per TRP.

In some embodiments, the first wireless communication entity may perform a channel access procedure per candidate COT. A configuration of the transmission gap may further include a maximum number of the candidate COTs initiated using a Type 1 channel access procedure. A total duration time of all of the candidate COTs initiated using the Type 1 channel access procedure may not be larger than the length of the transmission gap. A configuration of the transmission gap further includes repetition information of the transmission gap. The repetition information of the transmission gap may include at least one of: a repetition factor or a time gap between two repetitions of the transmission gap.

In some embodiments, the first wireless communication entity may send the positioning reference signal in multiple successfully accessed channels, upon the following condition being satisfied: the channels are continuous and a number of the continuous channels is not less than a threshold. The first wireless communication entity may send the positioning reference signal in a channel pattern, upon the following condition being satisfied: a successfully accessed channel corresponds to the channel pattern. The channel pattern can be configured by a core network entity. The second wireless communication entity may receive the positioning reference signal according to the channel pattern.

In some embodiments, a transmission of the positioning reference signal and a transmission of another positioning reference signal sent by another first wireless communication entity can be configured in a comb-based multiplexing manner. The first wireless communication entity may send accessed channel information and a configuration of the positioning reference signal to a third wireless communication entity. The accessed channel information may include at least one of: IDs of accessed RB sets, start locations of the accessed RB sets in a frequency domain, or a bandwidth of each of the accessed RB sets. The configuration of the positioning reference signal may include at least one of: a comb size of the positioning reference signal; or a comb offset of the positioning reference signal.

In some embodiments, the one or more channel occupancy parameters can be sent by the first or second communication entity to a core network entity. The one or more channel occupancy parameters may include at least one of: a ID of a COT; a length of the COT; a starting time of the COT; IDs of RB sets occupied for the positioning reference signal within the COT; start locations of the RB sets within the COT in a frequency domain; or a bandwidth of each of the RB sets within the COT.

In some embodiments, the second communication entity may receive the positioning reference signal, which is a DL-PRS, according to a reception configuration configured by a higher layer of the first communication entity or a core network entity. The reception configuration may include a first search space set group and a second search space set group corresponding to a COT. The first search space set group can be configured to detect DCI outside of the COT. The second search space set group can be configured to receive the DL-PRS within the COT. The second search space set group can be associated with a period of the positioning reference signal resource.

In some embodiments, the reception configuration may include a search window, where the search window is periodic or aperiodic. If the search window is periodic, a configuration of the search window may include at least one of: a length of the search window, a period of the search window, or a start time of a first period of the search window. If the search window is aperiodic, a configuration of the search window may include at least one of: a length of the search window, or a period of the search window. The reception configuration may include a search space set group corresponding to the search window. The search space set group can be configured to receive the DL-PRS within the search window. The second communication entity may receive the positioning reference signal, which is a DL-PRS, continuously within the search window.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example configuration for transmission and reception of positioning reference signal, in accordance with some embodiments of the present disclosure;

FIG. 4 illustrates an example configuration for transmission and reception of positioning reference signal, in accordance with some embodiments of the present disclosure;

FIG. 5 illustrates an example configuration for transmission and reception of positioning reference signal, in accordance with some embodiments of the present disclosure;

FIG. 6 illustrates an example configuration for transmission and reception of positioning reference signal, in accordance with some embodiments of the present disclosure;

FIG. 7 illustrates an example configuration for transmission and reception of positioning reference signal, in accordance with some embodiments of the present disclosure;

FIG. 8 illustrates an example configuration for transmission and reception of positioning reference signal, in accordance with some embodiments of the present disclosure;

FIG. 9 illustrates an example configuration for transmission and reception of positioning reference signal, in accordance with some embodiments of the present disclosure;

FIG. 10 illustrates an example configuration for transmission and reception of positioning reference signal, in accordance with some embodiments of the present disclosure;

FIG. 11 illustrates an example configuration for transmission and reception of positioning reference signal, in accordance with some embodiments of the present disclosure;

FIG. 12 illustrates an example configuration for transmission and reception of positioning reference signal, in accordance with some embodiments of the present disclosure;

FIG. 13 illustrates an example configuration for transmission and reception of positioning reference signal, in accordance with some embodiments of the present disclosure;

FIG. 14 illustrates an example configuration for transmission and reception of positioning reference signal, in accordance with some embodiments of the present disclosure;

FIG. 15 illustrates an example configuration for transmission and reception of positioning reference signal, in accordance with some embodiments of the present disclosure; and

FIG. 16 illustrates a flow diagram of an example method for transmission and reception of positioning reference signal, in accordance with an embodiment of the present disclosure.

### DETAILED DESCRIPTION

### 1. Mobile Communication Technology and Environment

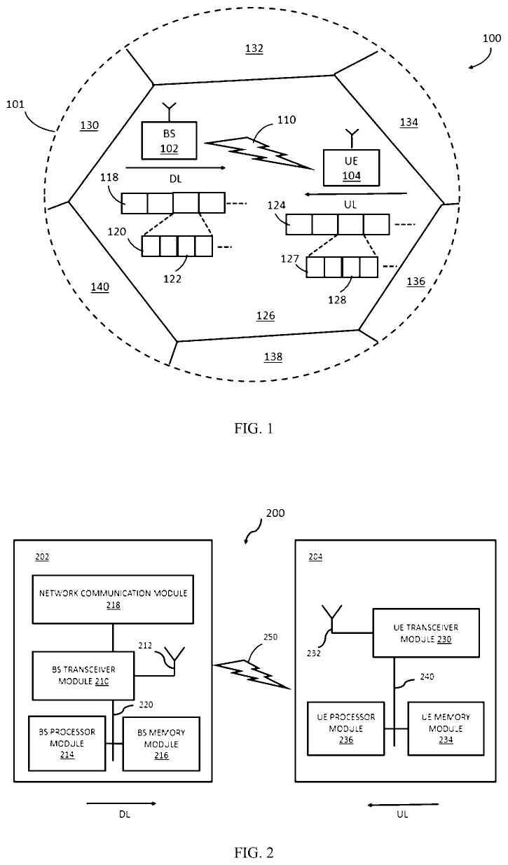

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Transmission and Reception of Positioning Reference Signal in a New Radio (NR) Unlicensed Band

In the NR system's Frequency Range 1 (FR1), both licensed and unlicensed bands exist. Licensed bands support both data transmission and positioning services, while unlicensed bands have idle spectrum that can be utilized for signal transmission. However, in NR in unlicensed band (NR-U), only data transmission and reception can be supported, and positioning services may not available. This disclosure focuses on the challenge of transmitting and receiving Downlink Positioning Reference Signal (DL-PRS) and Uplink Sounding Reference Signal (UL SRS) for positioning purposes in the unlicensed band. Various solutions are provided to address the transmission and reception of DL-PRS and UL SRS for positioning in NR-U.

In NR-U, transmission and reception of DL/UL data can be supported. For DL positioning, the gNB may transmit DL-PRS to the UE via the Uu interface, and the UE may measure DL-PRS to obtain positioning measurements. For UL positioning, the UE can transmit UL SRS for positioning purposes via the Uu interface, and the gNB may measure the SRS to obtain positioning measurements. However, the current NR system only supports positioning services in the licensed band of FR1, posing a problem for transmitting and receiving DL-PRS and UL SRS for positioning purposes in the unlicensed band of FR1.

### Implementation Example 1: Configuration of CAPC for DL-PRS/Positioning SRS

In a unlicensed band, a gNB/UE performing transmissions on channels can perform the channel access procedures for accessing the channels on which the transmissions are performed. One type of channel access procedure for data transmission purpose in NR-U can be Type 1 channel access procedure. In Type 1 channel access procedure, the sensing duration can be random, which is related to Channel Access Priority Class (CAPC). There are four CAPCs for DL and UL, respectively. Each CAPC can be corresponding to an allowed contention window size and a maximum Channel Occupancy Time (COT). Table 1 and Table 2 show the association among CAPC, allowed contention size and maximum COT for DL and UL, respectively. A gNB/UE can perform Type1 channel access procedure using any CAPC for DL/UL transmissions. After gNB/UE accesses the channel successfully based on Type 1 channel access procedure using one CAPC, DL/UL transmission time can not exceed the maximum COT associated with this CAPC. However, how to access the channel(s) to transmit DL-PRS/UL SRS for positioning purpose is a problem. A solution to access the channel(s) to transmit DL-PRS/UL SRS for positioning is based on Type 1 channel access procedure. In this implementation example, CAPC for DL-PRS/UL SRS for positioning is designed and configured.

TABLE 1
CAPC for DL

| Channel | | | | | | |
|---|---|---|---|---|---|---|
| Access | | | | | | |
| Priority | | | | | | allowed |
| Class (p) | mₚ | CW_{min, p} | CW_{max, p} | T_{m cot, p} | | CWₚsizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

TABLE 2
CAPC for UL

| Channel | | | | | | |
|---|---|---|---|---|---|---|
| Access | | | | | | |
| Priority | | | | | | allowed |
| Class (p) | mₚ | CW_{min, p} | CW_{max, p} | T_{ulm cot, p} | | CWₚ sizes |
| 1 | 2 | 3 | 7 | 2 | ms | {3, 7} |
| 2 | 2 | 7 | 15 | 4 | ms | {7, 15} |
| 3 | 3 | 15 | 1023 | 6 or 10 | ms | {15, 31, 63, 127, |
| | | | | | | 255, 511, 1023} |
| 4 | 7 | 15 | 1023 | 6 or 10 | ms | {15, 31, 63, 127, |
| | | | | | | 255, 511, 1023} |

For DL-PRS CAPC table, there are two alternatives:
(1) CAPC table for DL data transmission can be reused. That is, the association among CAPC, contention window size and the maximum COT continues to use the association of that for the DL data transmission, as shown in Table 1.
(2) Specific CAPC table for DL-PRS can be preconfigured. The parameters of DL-PRS CAPC table can be related to the configuration of DL-PRS. The parameters of DL-PRS CAPC table may at least include the minimum contention window size, the maximum contention window size, allowed contention window size and the maximum COT. The configuration of DL-PRS may include one or more: priority of DL-PRS, duration of DL-PRS transmission, repetition factor of DL-PRS, time gap between two repetitions of DL-PRS and DL-PRS period.
   The maximum COT of DL-PRS CAPC table is related to the duration of DL-PRS transmission. The duration of DL-PRS transmission depends on repetition factor of DL-PRS, time gap between two repetitions of DL-PRS and DL-PRS period.
   The minimum contention window size, the maximum contention window size and the allowed contention window size of DL-PRS CAPC table are related to DL-PRS priority.
   The DL-PRS CAPC value of DL-PRS CAPC table is related to DL-PRS priority. The mapping between DL-PRS CAPC value and DL-PRS priority can be established.

For DL-PRS transmission purpose, CAPC can be configured by Location Management Function (LMF), and can be transmitted by LMF to gNB via NR Positioning Protocol A (NRPPa). Alternatively, CAPC for DL-PRS transmission purpose can be determined by higher layer of gNB, e.g., a RRC/MAC CE.

CAPC for DL-PRS transmission purpose can be configured/determined per Physical Frequency Layer (PFL). Alternatively, CAPC for DL-PRS transmission purpose can be configured/determined per DL-PRS resource set. Alternatively, CAPC for DL-PRS transmission purpose can be configured/determined per DL-PRS resource.

There are two alternatives for configuration/determination of CAPC for DL-PRS transmission:
(1) CAPC for DL-PRS transmission purpose can be indicated by an IE (Information Element) explicitly.
(2) The configuration/determination of DL-PRS CAPC can be associated with the configuration of DL-PRS. The configuration of DL-PRS includes one or more: priority of DL-PRS, duration of DL-PRS transmission, repetition factor of DL-PRS, time gap between two repetitions of DL-PRS and DL-PRS period. The association between DL-PRS CAPC and the configuration of DL-PRS may include one or more:
   The maximum COT corresponding to CAPC can be associated with the duration of DL-PRS transmission, where the duration of DL-PRS transmission depends on repetition factor of DL-PRS, time gap between two repetitions of DL-PRS and DL-PRS period. That is, there is a mapping relationship between the maximum COT and the duration of DL-PRS transmission. If duration of DL-PRS transmission is obtained, the maximum COT can be got based on this association. Then, CAPC for DL-PRS transmission purpose can be obtained according to the corresponding maximum COT in DL-PRS CAPC table.
   The minimum contention window size, the maximum contention window size and the allowed contention window size corresponding to CAPC can be associated with DL-PRS priority. That is, there is a mapping relationship between the allowed contention window size and DL-PRS priority. If DL-PRS priority is known, the allowed contention window size can be got. Then, according to the corresponding allowed contention window size in DL-PRS CAPC table, CAPC for DL-PRS transmission purpose can be obtained.
   CAPC value for DL-PRS transmission can be associated with DL-PRS priority. That is, there is a mapping relationship between DL-PRS CAPC value and DL-PRS priority. If DL-PRS priority is known, CAPC value for DL-PRS transmission can be obtained.

For CAPC table for UL SRS transmission for positioning, there can be two alternatives:
(1) CAPC table for UL data transmission can be reused. That is, the association among CAPC, contention window size and the maximum COT continues to use the association of that for the UL data transmission, as shown in Table 2.
(2) Specific CAPC table for UL positioning SRS can be preconfigured. The parameters of UL positioning SRS CAPC table are related to the configuration of UL SRS. The parameters of UL positioning SRS CAPC table at least include the minimum contention window size, the maximum contention window size, allowed contention window size and the maximum COT. The configuration of UL positioning SRS may include one or more: priority of positioning SRS, duration of positioning SRS transmission, number of symbols of positioning SRS, or positioning SRS period.
   The maximum COT of positioning SRS CAPC table is related to the duration of positioning SRS transmission. The duration of positioning SRS transmission depends on number of symbols of positioning SRS and positioning SRS period.
   The minimum contention window size, the maximum contention window size and the allowed contention window size of positioning SRS CAPC table are related to positioning SRS priority.
   The positioning SRS CAPC value of positioning SRS CAPC table is related to positioning SRS priority. The mapping between positioning SRS CAPC value and positioning SRS priority can be established.

For positioning SRS transmission purpose, CAPC can be configured by Location Management Function (LMF), and can be transmitted by LMF to UE via LTE Positioning Protocol (LPP). Alternatively, CAPC for positioning SRS transmission purpose can be configured/determined by higher layer of a gNB/UE, e.g., a RRC/MAC CE.

In RRC_CONNECTED mode, CAPC for positioning SRS transmission purpose can be configured/determined per Bandwidth Part (BWP). Alternatively, in RRC_CONNECTED mode, CAPC for positioning SRS transmission purpose can be configured/determined per positioning SRS resource set. Alternatively, in RRC_CONNECTED mode, CAPC for positioning SRS transmission purpose can be configured/determined per positioning SRS resource.

In RRC_INACTIVE mode, CAPC for positioning SRS transmission purpose can be configured/determined per positioning SRS resource set. Alternatively, in RRC_INACTIVE mode, CAPC for positioning SRS transmission purpose can be configured/determined per positioning SRS resource.

There can be two alternatives for configuration/determination of CAPC for positioning SRS transmission:
(1) CAPC for positioning SRS transmission purpose can be indicated by an IE (Information Element) explicitly.
(2) The configuration/determination of positioning SRS CAPC can be associated with the configuration of positioning SRS. The configuration of positioning SRS may include one or more: priority of positioning SRS, duration of positioning SRS transmission, number of symbols of positioning SRS, or positioning SRS period. The association between positioning SRS CAPC and the configuration of positioning SRS includes one or more:
   The maximum COT corresponding to CAPC can be associated with the duration of positioning SRS transmission, where the duration of positioning SRS transmission depends on number of symbols of positioning SRS and positioning SRS period. That is, there is a mapping relationship between the maximum COT and the duration of positioning SRS transmission. If duration of positioning SRS transmission is obtained, the maximum COT can be got based on this association. Then, CAPC for positioning SRS transmission purpose can be obtained according to the corresponding maximum COT in positioning SRS CAPC table.
   The minimum contention window size, the maximum contention window size and the allowed contention window size corresponding to CAPC can be associated with positioning SRS priority. That is, there is a mapping relationship between the allowed contention window size and positioning SRS priority. If positioning SRS priority is known, the allowed contention window size can be got. Then, according to the corresponding allowed contention window size in positioning SRS CAPC table, CAPC for positioning SRS transmission purpose can be obtained.
   CAPC value for positioning SRS transmission can be associated with positioning SRS priority. That is, there is a mapping relationship between positioning SRS CAPC value and positioning SRS priority. If positioning SRS priority is known, CAPC value for positioning SRS transmission can be obtained.

### Implementation Example 2: DL-PRS/Positioning SRS Transmission Based on Type 2 Channel Access Procedure

For DL/UL data transmission in current NR-U, another channel access procedure is Type 2 channel access procedure, where the sensing duration is fixed. Type 2 channel access procedure is subdivided into three type channel access procedures, these are Type 2A, Type 2B and Type 2C. Another solution to access the channel(s) to transmit DL-PRS/UL SRS for positioning is based on Type 2 channel access procedure.

DL channel occupancy can be initiated by a gNB for DL-PRS transmission using Type 2A channel occupancy procedure, if DL-PRS transmission duration is at most 1 ms and the DL-PRS transmission duty cycle is at most 1/20, and in addition if one or more of the following conditions can be satisfied:
CAPC value of DL-PRS is less than or equal to a CAPC threshold.
   The CAPC threshold can be preconfigured.
   Alternatively, the CAPC threshold can be determined by higher layer of gNB, e.g., RRC, MAC CE.
   Alternatively, the CAPC threshold can be configured by LMF, and transmitted to gNB via NRPPa.
Priority value of DL-PRS is less than a priority threshold.
   The priority threshold can be preconfigured.
   Alternatively, the priority threshold can be determined by higher layer of gNB, e.g., RRC, MAC CE.
   Alternatively, the priority threshold can be configured by LMF, and transmitted to gNB via NRPPa.
DL-PRS transmission is broadcast to multiple UEs.

If a UE initiates a COT for UL transmission and shares the COT to gNB for DL transmission, the gNB can transmit DL-PRS in the shared COT following UL transmission using Type 2 channel access procedure, if the CAPC value of DL-PRS is less than or equal to the CAPC value used to initiate the shared COT. If a gNB initiates a COT for DL transmission and shares the COT to UE for UL transmission, the UE can transmit UL positioning SRS in the shared COT following DL transmission using Type 2 channel access procedure, if the CAPC value of UL positioning SRS is less than or equal to the CAPC value used to initiate the shared COT. If a gNB initiates a COT for DL transmission and shares the COT to UE for UL transmission, it can transmit DL-PRS following UL transmission using Type 2 channel access procedure, if any gap between any two transmissions in this shared COT is at most 25 microseconds.

### Implementation Example 3: Channel Access for DL-PRS Transmission Following/Followed by DL Data Transmission

For DL data transmission and DL-PRS transmission, there may be two cases: DL-PRS transmission follows DL data transmission, DL-PRS transmission is followed by DL data transmission. In such cases, how to access channel(s) for DL-PRS transmission and DL data transmission needs to be considered. In this implementation example, some solutions are provided for channel access to transmit DL-PRS following/followed by DL data.

Consider the case that DL-PRS transmission is followed by DL data transmission without time gap. DL-PRS transmission may not be over at the beginning of DL data transmission. FIG. 3 shows an illustration on DL-PRS transmission followed by DL data transmission. If a gNB intends to transmit DL-PRS transmission using Type 1 channel access procedure with a corresponding DL-PRS CAPC, and the gNB intends to transmit DL data using Type 1 channel access procedure with a corresponding CAPC, the following can be applied:
The gNB can initiate the channel occupancy using the DL-PRS CAPC value and may transmit DL-PRS transmission. If the DL-PRS CPAC value corresponding to DL-PRS transmission is larger than or equal to the CAPC value corresponding to DL data transmission, the gNB can directly continue to transmit DL data from the beginning of DL data transmission without a gap. The total of transmission duration of DL-PRS transmission and DL data transmission can not exceed the maximum COT corresponding to the DL-PRS CAPC value.
   Otherwise, the gNB can terminate DL-PRS transmission by dropping the transmission on symbols of at least the last DL-PRS transmission before DL data transmission, and attempt to initiate the channel occupancy for DL data transmission using the CAPC value corresponding to DL data transmission.
   Otherwise, alternatively, the gNB can transmit DL-PRS transmission completely and ignore DL data transmission.
Alternatively, the gNB can determine a unified CAPC value to initiate a channel occupancy for DL-PRS transmission and DL data transmission. The unified CAPC value is related to DL-PRS transmission duration and DL data transmission duration. The maximum COT corresponding to the unified CAPC value can be larger than or equal to the total of transmission duration of DL-PRS transmission and DL data transmission. The channel occupancy can be initiated at the beginning of DL-PRS transmission using the unified CAPC value and DL-PRS transmission can be transmitted. If DL-PRS transmission is not over before the beginning of DL data transmission, and if the DL-PRS CPAC value corresponding to DL-PRS transmission is larger than or equal to the CAPC value corresponding to DL data transmission, the gNB can directly continue to transmit DL data from the beginning of DL data transmission without a gap.
   If DL-PRS transmission is not over before the beginning of DL data transmission, and if the DL-PRS CPAC value corresponding to DL-PRS transmission is less than the CAPC value corresponding to DL data transmission, the gNB can terminate DL-PRS transmission by dropping the transmission on symbols of at least the last DL-PRS transmission before DL data transmission, and attempt to initiate the channel occupancy for DL data transmission using the CAPC value corresponding to DL data transmission.
   Alternatively, if DL-PRS transmission is not over before the beginning of DL data transmission, and if the DL-PRS CPAC value corresponding to DL-PRS transmission is less than the CAPC value corresponding to DL data transmission, the gNB can transmit DL-PRS transmission completely and ignore DL data transmission.
Alternatively, if the DL-PRS CPAC value corresponding to DL-PRS transmission is larger than the CAPC value corresponding to DL data transmission, the gNB can transmit DL data transmission using the CAPC value corresponding to DL data transmission and ignore DL-PRS transmission. If the DL-PRS CPAC value corresponding to DL-PRS transmission is less than the CAPC value corresponding to DL data transmission, the gNB can transmit DL-PRS transmission using the DL-PRS CAPC value corresponding to DL-PRS transmission and ignore DL data transmission. If the DL-PRS CPAC value corresponding to DL-PRS transmission is equal to the CAPC value corresponding to DL data transmission, the gNB can initiate the channel occupancy using the DL-PRS CAPC value and transmit DL-PRS transmission, then directly continue to transmit DL data from the beginning of DL data transmission without a gap.
   FIG. 3 provides an illustration on DL-PRS transmission followed by DL data transmission without a gap.

Consider the case that DL data transmission is followed by DL-PRS transmission without time gap. DL data transmission may be not over at the beginning of DL-PRS transmission. FIG. 4 shows an illustration on DL data transmission followed by DL-PRS transmission. If a gNB intends to transmit DL-PRS transmission using Type 1 channel access procedure with a corresponding DL-PRS CAPC, and the gNB intends to transmit DL data using Type 1 channel access procedure with a corresponding CAPC, the following can be applied:
The gNB can initiate the channel occupancy using the CAPC value corresponding to DL data transmission and transmit DL data transmission completely. If the CPAC value corresponding to DL data transmission is larger than or equal to the DL-PRS CAPC value corresponding to DL-PRS transmission, the gNB can directly continue to transmit DL-PRS transmission from the end of DL data transmission without a gap by dropping the DL-PRS transmission on symbols of the DL-PRS transmission time colliding with DL data transmission. The total of transmission duration of DL data transmission and DL-PRS transmission can not exceed the maximum COT corresponding to the CAPC value of DL data transmission. Otherwise, the gNB can ignore DL-PRS transmission.
Alternatively, the gNB can determine a unified CAPC value to initiate a channel occupancy for DL data transmission and DL-PRS transmission. The unified CAPC value is related to DL data transmission duration and DL-PRS transmission duration. The maximum COT corresponding to the unified CAPC value can be larger than or equal to the total of transmission duration of DL data transmission and DL-PRS transmission. The channel occupancy is initiated at the beginning of DL data transmission using the unified CAPC value and DL data transmission can be transmitted completely. If DL data transmission is not over before the beginning of DL-PRS transmission, and if the CPAC value corresponding to DL data transmission is larger than or equal to the DL-PRS CAPC value corresponding to DL-PRS transmission, the gNB can directly continue to transmit DL-PRS transmission from the end of DL data transmission without a gap by dropping the DL-PRS transmission on symbols of the DL-PRS transmission time colliding with DL data transmission. If DL data transmission is not over before the beginning of DL-PRS transmission, and if the CPAC value corresponding to DL data transmission is less than the DL-PRS CAPC value corresponding to DL-PRS transmission, the gNB ignores DL-PRS transmission.
Alternatively, if the CPAC value corresponding to DL data transmission is larger than the DL-PRS CAPC value corresponding to DL-PRS transmission, the gNB can transmit DL-PRS transmission using the DL-PRS CAPC value corresponding to DL-PRS transmission and ignore DL data transmission. If the CPAC value corresponding to DL data transmission is less than the DL-PRS CAPC value corresponding to DL-PRS transmission, the gNB can transmit DL data transmission using the CAPC value corresponding to DL data transmission and ignore DL-PRS transmission. If the CPAC value corresponding to DL data transmission is equal to the DL-PRS CAPC value corresponding to DL-PRS transmission, the gNB can initiate the channel occupancy using the CAPC value corresponding to DL data transmission and transmit DL data transmission completely, then the gNB directly continues to transmit DL-PRS transmission from the end of DL data transmission without a gap by dropping the DL-PRS transmission on symbols of the DL-PRS transmission time colliding with DL data transmission.
   FIG. 4 provides an illustration on DL data transmission followed by DL-PRS transmission without a gap.

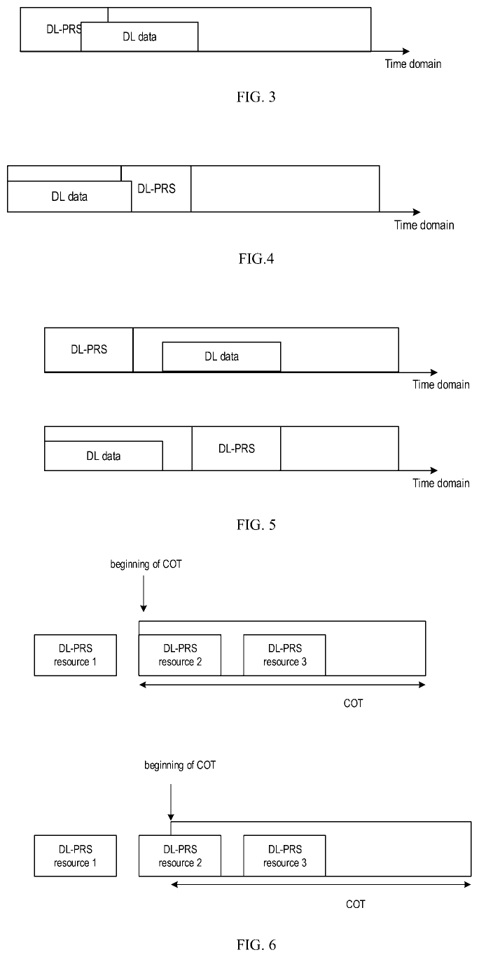

Consider the case that DL-PRS transmission is followed by or follows DL data transmission with a time gap. That is, DL-PRS transmission is transmitted completely before the beginning of DL data, or DL data is transmitted completely before the beginning of DL-PRS transmission. FIG. 5 shows an illustration on DL-PRS transmission following/followed by DL data transmission. If a gNB intends to transmit DL-PRS transmission using Type 1 channel access procedure with a corresponding DL-PRS CAPC, and the gNB intends to transmit DL data using Type 1 channel access procedure with a corresponding CAPC, the following can be applied:
If the gap between DL data transmission and DL-PRS transmission is at most 25 microseconds, an unified CAPC value can be determined by a gNB. The unified CAPC value is related to DL-PRS transmission duration and DL data transmission duration. The maximum COT corresponding to the unified CAPC value can be larger than or equal to the total of transmission duration of DL-PRS transmission and DL data transmission. The channel occupancy is initiated at the beginning of the first DL transmission using the unified CAPC value, and Type 2 channel access procedure can be used to transmit the next DL transmission. If the gap between DL data transmission and DL-PRS transmission is larger than 25 microseconds, the gNB can initiate two COTs for DL-PRS transmission and DL data transmission using their corresponding CAPC, respectively.
The gNB can initiate a COT for the first DL transmission using the corresponding CAPC value and transmit the first DL transmission. If the gap between DL data transmission and DL-PRS transmission is at most 25 microseconds, Type 2 channel access procedure can be used to transmit the next DL transmission. If the gap between DL data transmission and DL-PRS transmission is larger than 25 microseconds, the gNB can initiate another COT for the next DL transmission using the corresponding CAPC value.
   FIG. 5 provides an illustration on DL-PRS transmission following/followed by DL data transmission with a gap.

For positioning SRS transmission, there also exists the case that positioning SRS transmission follows or is followed by UL data transmission. The solutions described above for DL transmission can also be applied to UL transmission with positioning SRS and PUCCH/PUSCH.

### Implementation Example 4: DL-PRS/Positioning SRS Transmission Based on Semi-Static Channel Occupancy

In implementation example #1 and implementation example #2, Type 1 and Type 2 channel access procedures belong to dynamic channel access procedure. For DL/UL data transmission in current NR-U, a period channel occupancy can be initiated by gNB/UE, which is semi-static channel occupancy. A period of semi-static channel occupancy consists of the maximum COT and the idle duration, where the idle duration follows the maximum COT and is at the end of the period. DL/UL transmission is transmitted during the maximum COT and not transmitted during the idle duration. However, how to transmit DL-PRS/positioning SRS based on semi-static channel occupancy is a problem. This implementation example provides some solutions for DL-PRS/positioning SRS transmission based on semi-static channel occupancy.

DL-PRS is a periodic reference signal and transmitted periodically. If DL-PRS is expected to be transmitted at the beginning of a period of semi-static channel occupancy, DL-PRS period needs to be related to the period of semi-static channel occupancy initiated by gNB. Thus, DL-PRS period can be associated with the period of semi-static channel occupancy initiated by gNB. The association between DL-PRS period and the period of semi-static channel occupancy initiated by gNB can be one or more of the following:
DL-PRS period can be equal to the period of semi-static channel occupancy initiated by gNB.
DL-PRS period can be an integer multiple of the period of semi-static occupancy initiated by gNB.

If a gNB transmits DL-PRS within the COT of semi-static channel occupancy initiated by gNB/UE, there can be an association among DL-PRS period, slot offset of DL-PRS resource set, slot offset of DL-PRS resource, symbol offset of DL-PRS resource and the period of semi-static channel occupancy, so as to guarantee DL-PRS transmission ends before the start of idle duration of the semi-static channel occupancy. If DL-PRS transmission overlaps with idle duration in one period of semi-static channel occupancy, one or more of the following is applied, where the detailed rules are provided in implementation example #6:
The DL-PRS resource is dropped.
The symbols of DL-PRS resource overlapping with the idle duration are dropped.

For UL positioning SRS, it can be transmitted semi-persistently and periodically. If positioning SRS is expected to be transmitted at the beginning of a period of semi-static channel occupancy initiated by UE, the period of positioning SRS needs to be related to the period of semi-static channel occupancy initiated by UE. Thus, the period of positioning SRS can be associated with the period of semi-static channel occupancy initiated by UE. The association between the period of positioning SRS and the period of semi-static channel occupancy initiated by UE can be one or more of the following:
The period of positioning SRS can be equal to the period of semi-static channel occupancy initiated by UE.
The period of positioning SRS can be an integer multiple of the period of semi-static occupancy initiated by UE.

If a UE transmits positioning SRS within the COT of semi-static channel occupancy initiated by UE/gNB, there can be an association among the period of positioning SRS, number of symbols of positioning SRS, start symbol offset of positioning SRS and the period of semi-static channel occupancy, so as to guarantee positioning SRS transmission ends before the start of idle duration of the semi-static channel occupancy. If positioning SRS transmission overlaps with idle duration in one period of semi-static channel occupancy, one or more of the following is applied, where the detailed rules are provided in implementation example #6:
The positioning SRS resource is dropped.
The symbols of positioning SRS resource overlapping with the idle duration are dropped.

### Implementation Example 5: Specific Configuration of Semi-Static Channel Occupancy for DL-PRS/Positioning SRS

In implementation example #4, by configuring the parameters of DL-PRS/positioning SRS, DL-PRS/positioning SRS transmission can be transmitted based on the current semi-static channel occupancy. Another solution for DL-PRS/positioning SRS periodical transmission is to configure the specific parameters of semi-static channel occupancy for DL-PRS/positioning SRS. In this implementation example, the specific parameters of semi-static channel occupancy for DL-PRS/positioning SRS are configured.

For semi-static channel occupancy for DL-PRS transmission purpose, it can be initiated by gNB on the channel(s) within the bandwidth of the serving cell and there is no constraint on number of radio frames. The period of DL-PRS semi-static channel occupancy can be related to DL-PRS period. The association between the period of DL-PRS semi-static channel occupancy and DL-PRS period can be one or more of the following:
The period of DL-PRS semi-static channel occupancy can be equal to DL-PRS period.
The period of DL-PRS semi-static channel occupancy can be an integer multiple of DL-PRS period.

The time offset of the first period of DL-PRS semi-static channel occupancy relative to the reference time can be configured, where the reference time can be SFN0/DFN0. This time offset of the first period of DL-PRS semi-static channel occupancy can be associated with the time offset of DL-PRS transmission, where time offset of DL-PRS transmission depends on slot offset of DL-PRS resource set, slot offset of DL-PRS resource and symbol offset of DL-PRS resource. In detail, the time offset of the first period of DL-PRS semi-static channel occupancy can be equal to the time offset of DL-PRS transmission.

The period of DL-PRS semi-static channel occupancy and the time offset of the first period of DL-PRS semi-static channel occupancy can be determined by higher layer of gNB, e.g., gNB's RRC. Alternatively, the period of DL-PRS semi-static channel occupancy and the time offset of the first period of DL-PRS semi-static channel occupancy can be preconfigured. Alternatively, the period of DL-PRS semi-static channel occupancy and the time offset of the first period of DL-PRS semi-static channel occupancy can be configured by LMF, and transmitted to gNB via NRPPa.

The semi-static channel occupancy initiated by gNB for DL-PRS transmission purpose can be used to transmit DL data and shared to transmit UL data/positioning SRS.

For semi-static channel occupancy for positioning SRS transmission purpose, it can be initiated by UE on the channel(s) within the bandwidth of the serving cell and there is no constraint on number of radio frames. The period of positioning SRS semi-static channel occupancy can be related to positioning SRS period. The association between the period of positioning SRS semi-static channel occupancy and positioning SRS period can be one or more of the following:
The period of positioning SRS semi-static channel occupancy can be equal to positioning SRS period.
The period of positioning SRS semi-static channel occupancy can be an integer multiple of positioning SRS period.

The time offset of the first period of positioning SRS semi-static channel occupancy relative to the reference time can be configured, where the reference time can be SFN0/DFN0. This time offset of the first period of positioning SRS semi-static channel occupancy can be associated with the time offset of positioning SRS transmission, where time offset of positioning SRS transmission depends on start symbol offset of positioning SRS. In detail, the time offset of the first period of positioning SRS semi-static channel occupancy can be equal to the time offset of positioning SRS transmission.

The period of positioning SRS semi-static channel occupancy and the time offset of the first period of positioning SRS semi-static channel occupancy can be configured by higher layer of gNB, e.g., gNB's RRC. Alternatively, the period of positioning SRS semi-static channel occupancy and the time offset of the first period of positioning SRS semi-static channel occupancy can be determined by higher layer of UE, e.g., UE's RRC. Alternatively, the period of positioning SRS semi-static channel occupancy and the time offset of the first period of positioning SRS semi-static channel occupancy can be preconfigured. Alternatively, the period of positioning SRS semi-static channel occupancy and the time offset of the first period of positioning SRS semi-static channel occupancy can be configured by LMF, and transmitted to UE via LPP.

The semi-static channel occupancy initiated by UE for positioning SRS transmission purpose can be used to transmit UL data and shared to transmit DL data/DL-PRS.

### Implementation Example 6: The Recommended DL-PRS/Positioning SRS Resource from LMF in Semi-Static Channel Occupancy

In semi-static channel occupancy, a gNB/UE performs sensing in the idle duration of the previous period for the COT of the adjacent next period. To improve the successful probability of channel access, there may not have DL/UL transmissions from any gNB/UE in the idle duration. Thus, if a gNB initiates a semi-static channel occupancy, it can report the semi-static channel occupancy related information to LMF. If there are multiple gNBs initiating the semi-static channel occupancy, they all transmit their own semi-static channel occupancy related information to LMF. The semi-static channel occupancy related information at least includes one or more of: the period of semi-static channel occupancy, time of idle duration, and COT length. When LMF receives the semi-static channel occupancy related information, it can recommend DL-PRS transmission resources to gNBs, where the recommended DL-PRS transmission resources can avoid the time and frequency resources occupied by multiple idle duration. Alternatively, LMF can transmit the semi-static channel occupancy related information/idle duration related information of other gNBs to a gNB, where the idle duration related information at least includes one or more of: time of idle duration, and frequency resource of idle duration. When a gNB receives the semi-static channel occupancy related information/idle duration related information of other gNBs, it can determine DL-PRS transmission resource by avoiding the time and frequency resources occupied by idle duration of other gNBs. Alternatively, LMF can transmit non-preferred resource for DL-PRS transmission to a gNB, where non-preferred resource for DL-PRS transmission is associated with the idle duration of multiple gNBs and the resource occupied by idle duration of multiple gNBs. When a gNB receives non-preferred resource for DL-PRS transmission, it can determine DL-PRS transmission resource by avoiding the non-preferred resource for DL-PRS transmission.

If a UE initiates a semi-static channel occupancy, it can report the semi-static channel occupancy related information to LMF. If there are multiple UEs initiating the semi-static channel occupancy, they all transmit their own semi-static channel occupancy related information to LMF. The semi-static channel occupancy related information at least includes one or more of: the period of semi-static channel occupancy, time of idle duration, and COT length. When LMF receives the semi-static channel occupancy related information, it can recommend positioning SRS transmission resources to the serving gNB, where the recommended positioning SRS transmission resources can avoid the time and frequency resources occupied by multiple idle duration. Alternatively, LMF can transmit the semi-static channel occupancy related information/idle duration related information of other UEs to the serving gNB, where the idle duration related information at least includes one or more of: time of idle duration, and frequency resource of idle duration. When the serving gNB receives the semi-static channel occupancy related information/idle duration related information of other UEs, it can determine positioning SRS transmission resource by avoiding the time and frequency resources occupied by idle duration of other UEs. Alternatively, LMF can transmit non-preferred resource for positioning SRS transmission to the serving gNB, where non-preferred resource for positioning SRS transmission is associated with the idle duration of multiple UEs and the resource occupied by idle duration of multiple UEs. When the serving gNB receives non-preferred resource for positioning SRS transmission, it can determine positioning SRS transmission resource by avoiding the non-preferred resource for positioning SRS transmission.

### Implementation Example 7: DL-PRS Transmission with Partial Resources/Symbols within COT

Since the configuration of DL-PRS, including transmission time of DL-PRS, is configured by LMF and COT is initiated by gNB, there may occur two cases: the start time of DL-PRS transmission is before the beginning of COT, the end time of DL-PRS transmission is after the end of COT. In these two cases, some DL-PRS resources/symbols are lying outside of COT, while some DL-PRS resources/symbols are within COT. In such cases, how to transmit DL-PRS resource is a problem. In this implementation example, some rules and configuration are provided for DL-PRS transmission with partial resources/symbols lying within COT.

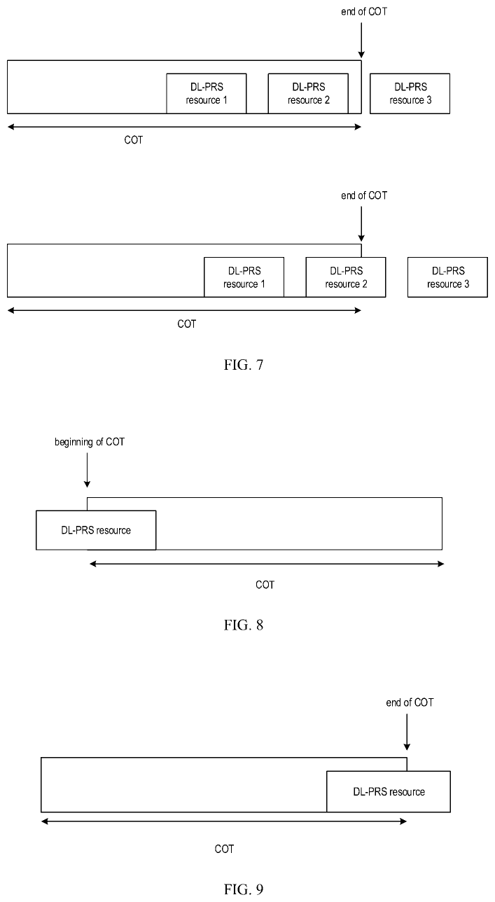

A gNB is configured to transmit multiple DL-PRS resources, and the gNB performs channel access for DL-PRS transmission. One case is that a gNB may initiate channel occupancy after some DL-PRS resource transmission time, as shown in FIG. 6. Another case is that DL-PRS transmission is not over after COT ends, as shown in FIG. 7. These two cases cause some DL-PRS resources/symbols are lying within COT while some DL-PRS resources/symbols are lying outside of COT.

FIG. 6 illustrates a COT which is initiated after some DL-PRS resource transmission time. FIG. 7 illustrates a COT which is ended before some DL-PRS resource transmission time. One solution is that a gNB determines whether to transmit DL-PRS transmission per DL-PRS resource. If one DL-PRS resource transmission time is completely lying within COT, this DL-PRS resource can be transmitted by a gNB in COT. If partial transmission time of one DL-PRS resource is within COT but some transmission time is lying outside of COT, this DL-PRS resource is dropped and can not be transmitted. If one DL-PRS resource transmission time is completely outside of COT, this DL-PRS resource is dropped and can not be transmitted.

Another solution is that a gNB can determine whether to transmit DL-PRS transmission per DL-PRS symbol. As shown in FIG. 8 and FIG. 9, some symbols of one DL-PRS resource are outside of COT and some symbols are lying within COT. One or more of the following rules can be applied to determine whether/how to transmit DL-PRS resource:
If all symbols of one DL-PRS resource are lying within COT, this DL-PRS resource can be transmitted in COT. Otherwise, the DL-PRS resource is dropped and can not be transmitted in COT.
Alternatively, if the number of symbols of one DL-PRS resource lying within COT is not less than a threshold, the DL-PRS symbols lying within COT can be transmitted in COT, and the DL-PRS symbols lying outside of COT is dropped and can not be transmitted. The threshold can be configured/determined by LMF/gNB. The threshold can be related to symbol numbers of the DL-PRS resource. The threshold can be associated with comb size of the DL-PRS resource.
Alternatively, some patterns can be configured/determined by LMF/gNB. If the DL-PRS symbols lying within COT are same as the configured patterns or include the configured patterns, the DL-PRS symbols satisfying the configured patterns can be transmitted in COT, and other DL-PRS symbols can be dropped and can not be transmitted. The pattern can be related to comb size and comb offset of DL-PRS resource.

FIG. 8 illustrates a COT which is initiated after some DL-PRS symbols transmission. FIG. 9 illustrates a COT which is ended before some DL-PRS symbols transmission. For UL positioning SRS transmission, there also exists the case: some positioning SRS resources/symbols are lying outside of COT, while some positioning SRS resources/symbols are within COT. In such case, whether/how to transmit positioning SRS is a problem. The solutions described above for DL-PRS transmission can be applied to UL positioning SRS transmission. In semi-static channel occupancy, DL-PRS/positioning SRS transmission time may overlap with the idle duration. If the DL-PRS/positioning SRS transmission occurs within the idle duration, the solutions described above can be applied to transmit DL-PRS/positioning SRS.

### Implementation Example 8: DL-PRS Transmission from Multiple gNBs Based on Dynamic Channel Access Procedure

To obtain the location estimation of a UE by Downlink Time Difference of Arrival (DL-TDOA) method and Multiple-Round Trip Time (Multi-RTT) method, multiple gNBs need to transmit DL-PRS to this UE. In current NR-U, the serving gNB accesses channel(s) by channel access procedure to transmit data, while the neighboring gNBs don't access channel(s) for data transmission. How to make multiple gNBs access channel(s) to transmit DL-PRS is a problem. In this implementation example, solutions are provided for channel access of multiple gNBs to transmit DL-PRS.

The neighboring gNBs can be allowed to access channel(s) to transmit DL-PRS based on Type 1 and/or Type 2 channel access procedure.

If the serving gNB initiates a channel occupancy for DL-PRS transmission purpose using Type 1 channel access procedure, a DL-PRS channel occupancy window related information can be notified by the serving gNB to neighboring gNBs. The serving gNB may notify neighboring gNBs the DL-PRS channel occupancy window related information via:
Xn interface.
Alternatively, LMF by NRPPa. That is, the serving gNB transmits the DL-PRS channel occupancy window related information to LMF via NRPPa, and then LMF transmits the DL-PRS channel occupancy window related information to neighboring gNBs via NRPPa.

In the DL-PRS channel occupancy window, the serving gNB and neighboring gNBs transmit DL-PRS only. In this case, for DL-PRS transmission of neighboring gNBs within the DL-PRS channel occupancy window, the following can be applied:
Neighboring gNBs can transmit DL-PRS without sensing.
Alternatively, neighboring gNBs can immediately transmit DL-PRS after at least a sensing slot duration is sensing to be idle, where a sensing slot is 9 microsecond.
Alternatively, neighboring gNBs can access the channel(s) within the DL-PRS channel occupancy window to transmit DL-PRS based on Type 2 channel access procedure.

Alternatively, in the DL-PRS channel occupancy window, the serving gNBs can transmit both DL-PRS and DL data, while neighboring gNBs can transmit DL-PRS only. In this case, for DL-PRS transmission of neighboring gNBs within the DL-PRS channel occupancy window, the following can be applied:
Neighboring gNBs can immediately transmit DL-PRS after at least a sensing slot duration is sensing to be idle, where a sensing slot is 9 microsecond.
Alternatively, neighboring gNBs can access the channel(s) within the DL-PRS channel occupancy window to transmit DL-PRS based on Type 2 channel access procedure.

The DL-PRS channel occupancy window length is not larger than the maximum COT. For configuration/determination of DL-PRS channel occupancy window length, the following can be applied:
The DL-PRS channel occupancy window length is configured by higher layer of gNB, e.g., gNB's RRC.
Alternatively, the DL-PRS channel occupancy window length is associated with CAPC. That is, there is a mapping relationship between DL-PRS channel occupancy window length and CAPC. If CAPC is indicated, DL-PRS channel occupancy window length can be obtained.

The DL-PRS channel occupancy window related information at least includes one or more of the following:
CAPC used to initiate the channel occupancy;
The channel occupancy time;
The start time of channel occupancy;
DL-PRS channel occupancy window length; or
The start time of DL-PRS channel occupancy window.

Neighboring gNBs receiving DL-PRS channel occupancy window related information can be determined by the serving gNB. Alternatively, neighboring gNBs can be determined by UE, and UE reports the identifier of neighboring gNBs to the serving gNB by Physical Uplink Control Channel/Physical Uplink Shared Channel (PUCCH/PUSCH). Alternatively, neighboring gNBs can be configured by LMF, and LMF transmit identifier information of neighboring gNBs to the serving gNB via NRPPa. If the serving gNB receives the identifier of neighboring gNBs, then the serving gNB may notify DL-PRS channel occupancy window related information to these neighboring gNBs.

If a neighboring gNB initiates a channel occupancy for DL-PRS transmission purpose using Type 1 channel access procedure, the channel occupancy related information can be notified by this neighboring gNB to other gNBs. The neighboring gNB may notify other gNBs the channel occupancy related information via:
Xn interface.
Alternatively, LMF by NRPPa. That is, the neighboring gNB transmits the channel occupancy related information to LMF via NRPPa, and then LMF transmits the channel occupancy related information to other gNBs via NRPPa.

Within this COT initiated by the neighboring gNB, the serving gNB and all the neighboring gNBs can transmit DL-PRS only. For DL-PRS transmission of gNBs within the COT, the following can be applied:
gNBs can transmit DL-PRS without sensing.
Alternatively, gNBs can immediately transmit DL-PRS after at least a sensing slot duration is sensing to be idle, where a sensing slot is 9 microsecond.
Alternatively, gNBs can access the channel(s) within the COT to transmit DL-PRS based on Type 2 channel access procedure.

The channel occupancy related information includes one or more of the following:
CAPC used to initiate the channel occupancy;
The channel occupancy time; or
The start time of channel occupancy.

Other gNBs receiving DL-PRS channel occupancy window related information can be determined by the initiating gNB. Alternatively, other gNBs can be configured by LMF, and LMF may transmit identifier information of other gNBs to the initiating gNB via NRPPa. If the initiating gNB receives the identifier of other gNBs, then the initiating gNB tells DL-PRS channel occupancy window related information to these other gNBs.

### Implementation Example 9: DL-PRS Transmission from Multiple gNBs Based on Semi-Static Channel Access Procedure

In implementation example 6, multiple gNBs accessing channel(s) for DL-PRS transmission are based on dynamic channel access procedure. In unlicensed band, another solution for multiple gNBs to access channel(s) for DL-PRS transmission is based on semi-static channel occupancy.

The serving gNB can initiate semi-static channel occupancy for DL-PRS transmission. If DL-PRS is transmitted by the serving gNB at the beginning of a period of the semi-static channel occupancy, the serving gNB tells a DL-PRS channel occupancy window related information to neighboring gNBs. The serving gNB tells neighboring gNBs the DL-PRS channel occupancy window related information via:
Xn interface.
Alternatively, LMF by NRPPa. That is, the serving gNB transmits the DL-PRS channel occupancy window related information to LMF via NRPPa, and then LMF transmits the DL-PRS channel occupancy window related information to neighboring gNBs via NRPPa.

In the DL-PRS channel occupancy window, the serving gNB and neighboring gNBs transmit DL-PRS only. In this case, for DL-PRS transmission of neighboring gNBs within the DL-PRS channel occupancy window, the following can be applied:
Neighboring gNBs can transmit DL-PRS without sensing.
Alternatively, neighboring gNBs can immediately transmit DL-PRS after at least a sensing slot duration is sensing to be idle, where a sensing slot is 9 microsecond.
Alternatively, neighboring gNBs can access the channel(s) within the DL-PRS channel occupancy window to transmit DL-PRS based on Type 2 channel access procedure.

Alternatively, in the DL-PRS channel occupancy window, the serving gNBs can transmit both DL-PRS and DL data, while neighboring gNBs can transmit DL-PRS only. In this case, for DL-PRS transmission of neighboring gNBs within the DL-PRS channel occupancy window, the following can be applied:
Neighboring gNBs can immediately transmit DL-PRS after at least a sensing slot duration is sensing to be idle, where a sensing slot is 9 microsecond.
Alternatively, neighboring gNBs can access the channel(s) within the DL-PRS channel occupancy window to transmit DL-PRS based on Type 2 channel access procedure.

The DL-PRS channel occupancy window length is not larger than the maximum COT of a period of the semi-static channel occupancy. For configuration/determination of DL-PRS channel occupancy window length, the following can be applied:
The DL-PRS channel occupancy window length is configured by higher layer of gNB, e.g., gNB's RRC.
Alternatively, the DL-PRS channel occupancy window length is associated with the period of the semi-static channel occupancy. That is, there is a mapping relationship between DL-PRS channel occupancy window length and the period of semi-static channel occupancy. If the period of semi-static channel occupancy is determined, DL-PRS channel occupancy window length can be obtained.

The DL-PRS channel occupancy window related information includes one or more of the following:
The period of semi-static channel occupancy;
The maximum COT of a period of semi-static channel occupancy;
The start time of a period of semi-static channel occupancy;
DL-PRS channel occupancy window length; or
The start time of DL-PRS channel occupancy window.

Neighboring gNBs receiving DL-PRS channel occupancy window related information can be determined by the serving gNB. Alternatively, neighboring gNBs can be determined by UE, and UE reports the identifier of neighboring gNBs to the serving gNB by Physical Uplink Control Channel/Physical Uplink Shared Channel (PUCCH/PUSCH). Alternatively, neighboring gNBs can be configured by LMF, and LMF transmit identifier information of neighboring gNBs to the serving gNB via NRPPa. If the serving gNB receives the identifier of neighboring gNBs, then the serving gNB tells DL-PRS channel occupancy window related information to these neighboring gNBs.

The neighboring gNB can initiate semi-static channel occupancy for DL-PRS transmission. If a neighboring gNB initiates a semi-static channel occupancy for DL-PRS transmission purpose, the channel occupancy related information can be notified by this neighboring gNB to other gNBs. The neighboring gNB may notify other gNBs the channel occupancy related information via:
Xn interface.
Alternatively, LMF by NRPPa. That is, the neighboring gNB transmits the channel occupancy related information to LMF via NRPPa, and then LMF transmits the channel occupancy related information to other gNBs via NRPPa.

Within the COT of a period of semi-static channel occupancy initiated by the neighboring gNB, the serving gNB and all the neighboring gNBs can transmit DL-PRS only. For DL-PRS transmission of gNBs within the COT of a period, the following can be applied:
gNBs can transmit DL-PRS without sensing.
Alternatively, gNBs can immediately transmit DL-PRS after at least a sensing slot duration is sensing to be idle, where a sensing slot is 9 microsecond.
Alternatively, gNBs can access the channel(s) within the COT to transmit DL-PRS based on Type 2 channel access procedure.

The channel occupancy related information includes one or more of the following:
The period of semi-static channel occupancy;
The maximum COT of a period of semi-static channel occupancy;
The start time of a period of semi-static channel occupancy.

Other gNBs receiving DL-PRS channel occupancy window related information can be determined by the initiating gNB. Alternatively, other gNBs can be configured by LMF, and LMF transmit identifier information of other gNBs to the initiating gNB via NRPPa. If the initiating gNB receives the identifier of other gNBs, then the initiating gNB tells DL-PRS channel occupancy window related information to these other gNBs.

The serving gNB and neighboring gNBs can share the COT initiated by UE to transmit DL-PRS.

If a UE initiates a semi-static channel occupancy and is not configured with the channel occupancy sharing information, the serving gNB can share the COT of the semi-static channel occupancy based on Type 2 channel access procedure. The channel occupancy sharing information can be provided by IE eg-COT-SharingList-r16. If the serving gNB successfully shares the COT of the semi-static channel occupancy initiated by UE, the serving gNB can notify neighboring gNBs a DL-PRS channel occupancy window related information. The serving gNB may notify neighboring gNBs the DL-PRS channel occupancy window related information via:
Xn interface.
Alternatively, LMF by NRPPa. That is, the serving gNB transmits the DL-PRS channel occupancy window related information to LMF via NRPPa, and then LMF transmits the DL-PRS channel occupancy window related information to neighboring gNBs via NRPPa.

In the DL-PRS channel occupancy window, the serving gNB and neighboring gNBs transmit DL-PRS only. In this case, for DL-PRS transmission of neighboring gNBs within the DL-PRS channel occupancy window, the following can be applied:
Neighboring gNBs can transmit DL-PRS without sensing.
Alternatively, neighboring gNBs can immediately transmit DL-PRS after at least a sensing slot duration is sensing to be idle, where a sensing slot is 9 microsecond.
Alternatively, neighboring gNBs can access the channel(s) within the DL-PRS channel occupancy window to transmit DL-PRS based on Type 2 channel access procedure.

Alternatively, in the DL-PRS channel occupancy window, the serving gNBs can transmit both DL-PRS and DL data, while neighboring gNBs can transmit DL-PRS only. In this case, for DL-PRS transmission of neighboring gNBs within the DL-PRS channel occupancy window, the following can be applied:
Neighboring gNBs can immediately transmit DL-PRS after at least a sensing slot duration is sensing to be idle, where a sensing slot is 9 microsecond.
Alternatively, neighboring gNBs can access the channel(s) within the DL-PRS channel occupancy window to transmit DL-PRS based on Type 2 channel access procedure.

The DL-PRS transmission of the serving gNB and neighboring gNBs can end before the beginning of the idle duration of the semi-static channel occupancy. The DL-PRS channel occupancy window length is not larger than the maximum COT of semi-static channel occupancy. If the serving gNB detects the UL transmission in slot n1 and the COT ends in slot n2, the DL-PRS channel occupancy window length is not larger than the n2−n1. The DL-PRS channel occupancy window length can be configured by higher layer of gNB, e.g., gNB's RRC. The DL-PRS channel occupancy window can be started from the detection time of UL transmission. Alternatively, the start time of DL-PRS channel occupancy window can be later than detection time of UL transmission, which can be configured/determined by higher layer of gNB.

The DL-PRS channel occupancy window related information includes one or more of the following:
The period of semi-static channel occupancy initiated by UE;
The maximum COT of a period of semi-static channel occupancy initiated by UE;
The start time of a period of semi-static channel occupancy initiated by UE;
DL-PRS channel occupancy window length;
The start time of DL-PRS channel occupancy window.

Neighboring gNBs receiving DL-PRS channel occupancy window related information can be determined by the serving gNB. Alternatively, neighboring gNBs can be determined by UE, and UE reports the identifier of neighboring gNBs to the serving gNB by Physical Uplink Control Channel/Physical Uplink Shared Channel (PUCCH/PUSCH). Alternatively, neighboring gNBs can be configured by LMF, and LMF transmit identifier information of neighboring gNBs to the serving gNB via NRPPa. If the serving gNB receives the identifier of neighboring gNBs, then the serving gNB tells DL-PRS channel occupancy window related information to these neighboring gNBs.

If a UE initiates a semi-static channel occupancy with configured grant transmission and is configured with the channel occupancy sharing information, the serving gNB can shares the COT of the semi-static channel occupancy by detecting UCI (Uplink Control Information), where UCI carries the COT sharing information. The channel occupancy sharing information can be provided by IE cg-COT-SharingList-r16. The COT sharing information can be provided by IE CG-COT-Sharing-r16. In the COT sharing information, an sharing offset and a sharing duration can be provided and carried in UCI. If the serving gNB detects a UCI including COT sharing information in slot n, the serving gNB can transmit DL transmission starting from slot n+sharing offset, and the DL transmission duration is indicated by the sharing duration. The DL transmission can be DL-PRS. If DL-PRS transmission is DL-PRS, the serving gNB tells a DL-PRS channel occupancy window related information to neighboring gNBs. The DL-PRS channel occupancy window length is not larger than the sharing duration indicated in UCI. The DL-PRS channel occupancy window can be started from slot n+sharing offset. Alternatively, the start time of DL-PRS channel occupancy window can be later than slot n+sharing offset, which can be configured/determined by higher layer of gNB.

Another solution is UE initiates a semi-static channel occupancy with configured grant transmission and can be configured with the specific channel occupancy sharing information for DL-PRS transmission. The specific channel occupancy sharing information for DL-PRS transmission can be configured by higher layer of gNB, e.g., gNB's RRC. In details, higher layer of gNB can configure a specific channel occupancy sharing list for DL-PRS transmission, which includes multiple rows indicating the channel occupancy sharing information. In multiple rows of the specific channel occupancy sharing list for DL-PRS transmission, one row indicates the channel occupancy is not available, other rows provide the specific channel occupancy sharing information for DL-PRS transmission. Each row indicating the specific channel occupancy sharing information at least includes a specific DL-PRS sharing offset and a specific DL-PRS sharing duration. Each row is indicated by a row index. The specific channel occupancy sharing information for DL-PRS transmission indicated by a row index can be carried in UCI. If the serving gNB detects a UCI including the specific channel occupancy information for DL-PRS in slot n, the serving gNB can transmit DL-PRS starting from slot n+specific DL-PRS sharing offset, and the DL-PRS transmission duration is indicated by the specific DL-PRS sharing duration. And the serving gNB tells a DL-PRS channel occupancy window related information to neighboring gNBs. The DL-PRS channel occupancy window length is not larger than the specific DL-PRS sharing duration indicated in UCI. The DL-PRS channel occupancy window can be started from slot n+specific DL-PRS sharing offset. Alternatively, the start time of DL-PRS channel occupancy window can be later than slot n+specific DL-PRS sharing offset, which can be configured/determined by higher layer of gNB.

The mechanism and configuration for DL-PRS transmission of multiple gNBs sharing the semi-static channel occupancy initiated by a UE can be applied to DL-PRS transmission of multiple gNBs sharing the COT initiated by a UE based on dynamic channel access procedure.

### Implementation Example 10: Definition on Channel Access for DL-PRS Transmission in Frequency Domain

The DL transmission with Physical Downlink Control Channel/Physical Downlink Shared Channel (PDCCH/PDSCH) and UL transmission with PUCCH/PUSCH/SRS are transmitted within Bandwidth Part (BWP) of the serving gNB. The frequency configuration of DL-PRS resource is defined in Physical Frequency Layer (PFL), which is independent on Bandwidth Part (BWP). How to access channel(s) for SL-PRS transmission in PFL in unlicensed band is a problem. In this implementation example, some configurations and procedures are introduced for DL-PRS transmission in PFL in unlicensed band.

In current NR-U, a channel refers to a RB set. One BWP of the serving gNB includes integer RB sets. The guard band can be configured between two continuous RB sets. In unlicensed band, PFL can be configured to include integer RB sets, where one RB set is a channel. Channel access operation in PFL in unlicensed band is performed per RB set. Guard band between two continuous RB sets can be configured by gNB's higher layer in PFL. Alternatively, there can be no guard band between two continuous RB sets in PFL. DL-PRS is transmitted in PFL in unlicensed band.

A gNB can access multiple channels for DL transmission. Assume that multiple channel set on which DL transmission is performed is C. Each channel is c_i, where c_iϵC, i=0, 1, . . . q−1, and q is the number of channels on which DL transmission is performed. In current NR-U, there are two types to access multiple channels, these are Type A multiple channel access procedures and Type B multiple channel access procedures. In type A multiple channel access procedures, gNB access each channel independently using Type 1 channel access procedure. In type B multiple channel access procedures, gNB firstly selects one channel cⱼ uniformly randomly from C and selects cⱼ no more than frequently than once every 1 second. Then, gNB perform channel access on channel cⱼ using Type 1 channel access procedure. For other channel cᵢ≠cⱼ and cᵢϵEC, the sensing of a fixed sensing duration for channel cᵢ before transmission on channel cⱼ is performed. If the channel cᵢ is sensed to be idle during the fixed sensing duration, the transmission is transmitted on channel cᵢ.

Type A multiple channel access procedures and Type B multiple channel access procedures can be applied to DL-PRS transmission in PFL, if a gNB intends to transmit DL-PRS on multiple channels. The configuration of PFL can newly add a parameter, where the parameter can be multiple channel access procedure type. That is, multiple channel access procedure type can be configured per PFL. Alternatively, multiple channel access procedure type can be configured per positioning service. Alternatively, the configuration of DL-PRS resource set can newly add a parameter, where the parameter can be multiple channel access procedure type. That is, multiple channel access procedure type can be configured per DL-PRS resource set. Alternatively, the configuration of DL-PRS resource can newly add a parameter, where the parameter can be multiple channel access procedure type. That is, multiple channel access procedure type can be configured per DL-PRS resource.

### Implementation Example 11: Configuration of DL-PRS Transmission Gap

A gNB can configure the DL-PRS transmission gap, which is dedicated for DL-PRS transmission, receiving and measuring. For DL-PRS transmission/receiving/measuring, one or more DL-PRS transmission gap can be configured/activated by higher layer of gNB, e.g., gNB's RRC, gNB's MAC CE. Each DL-PRS transmission gap is associated with a DL-PRS transmission gap ID. The configuration of each DL-PRS transmission gap at least includes the following:
DL-PRS transmission gap ID;
Length of DL-PRS transmission gap;
Period of DL-PRS transmission gap;
The reference point in time domain, e.g., SFN0, DFN0; or
Offset of DL-PRS transmission gap relative to the reference point in time domain.

In the DL-PRS transmission gap, gNB can perform channel access procedure before each DL-PRS resource transmission and initiate channel occupancy for every DL-PRS resource transmission. That is, the channel access procedure can be performed by gNB per DL-PRS resource. One or more of the following channel access procedures can be applied to the channel occupancy initiation for DL-PRS resource transmission:
A gNB senses at least one sensing slot immediately before DL-PRS resource transmission, where a sensing slot is 9 microseconds. If at least one sensing slot is sensed to be idle, gNB transmits DL-PRS resource immediately following the sensing slot.
Alternatively, a gNB senses at least a sensing interval immediately before DL-PRS resource transmission, where the sensing interval is 25 microseconds. The sensing interval includes two sensing slot, where a sensing slot is 9 microseconds, and where one sensing slot is at the start of the sensing interval and the other sensing slot is at the end of the sensing interval. If both two sensing slots of the sensing interval are sensed to be idle, gNB transmits DL-PRS resource immediately following the sensing interval.
Alternatively, a gNB senses at least a sensing duration immediately before DL-PRS resource transmission, where the sensing duration is 16 microseconds. The sensing duration includes one sensing slot, where a sensing slot is 9 microseconds and is at the end of the sensing duration. If the total of at least 5 microseconds in the sensing duration with at least of 4 microseconds occurring in the sensing slot is sensed to be idle, gNB transmits DL-PRS resource immediately following the sensing duration.
Alternatively, a gNB can initiate a COT for DL-PRS resource transmission based on Type 1 channel access procedure using CAPC value corresponding to the DL-PRS resource.

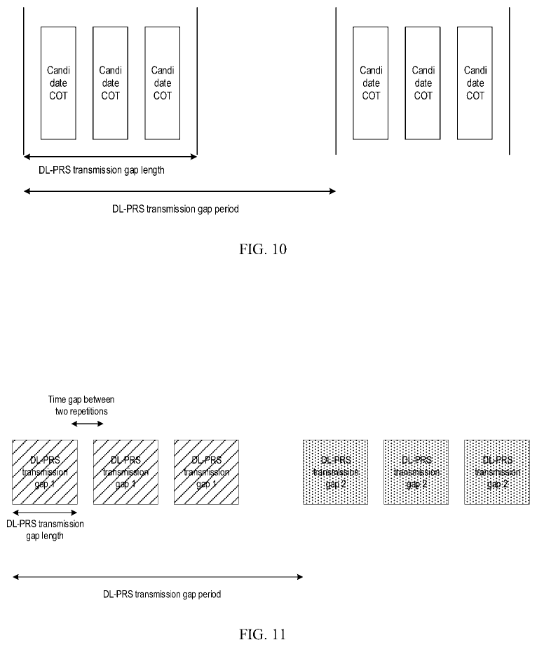

If the gap between two DL-PRS resource is less than one sensing slot/16 microseconds, gNB can initiate the channel occupancy for the first DL-PRS resource and directly transmit the next DL-PRS resource without sensing. However, if channel access operation is performed before every DL-PRS resource transmission, gNB needs to sense frequently and the failure probability of channel occupancy is large. To reduce the number of channel access operation and improve the success probability of channel occupancy, a gNB can configure multiple candidate COTs for DL-PRS transmission in each DL-PRS transmission gap. Thus, in addition to the configuration of each DL-PRS transmission gap described above, the configuration of DL-PRS transmission gap can further include number of candidate COTs and the configuration of the candidate COTs. FIG. 10 shows an illustration on DL-PRS transmission gap and candidate COTs. The candidate COTs can be configured by higher layer of gNB, e.g., gNB's RRC, gNB's MAC CE. The candidate COT in a DL-PRS transmission gap can be periodic or aperiodic.

If the candidate COT in a DL-PRS transmission gap is periodic, the configuration of the candidate COT at least includes the following:
The candidate COT ID;
Length of the candidate COT;
Period of the candidate COT; or
Offset of the first candidate COT relative to the start time of the DL-PRS transmission gap.

If the candidate COT in a DL-PRS transmission gap is aperiodic, the configuration of the candidate COT at least includes the following:
The candidate COT ID;
Length of the candidate COT; or
Offset of the candidate COT relative to the start time of the DL-PRS transmission gap.

FIG. 10 provides an illustration on DL-PRS transmission gap and candidate COTs. The candidate COT can be configured per DL-PRS transmission gap. That is, for different DL-PRS transmission gaps, the configuration of the candidate COTs is different. Alternatively, the candidate COT can be configured per PFL. That is, for DL-PRS transmission gaps in the same PFL, the configuration of the candidate COTs is the same. For DL-PRS transmission gaps in different PFLs, the configuration of the candidate COTs is different. Alternatively, the candidate COT can be configured per serving cell. That is, different gNB can configure different candidate COT. Alternatively, the candidate COT can be configured per UE. That is, the candidate COT can configured by different gNB to be the same, if the DL-PRS transmission intends to be received and measured by the same UE.

For a DL-PRS resource, a gNB determines which candidate COT the DL-PRS resource transmission time belongs to based on the configuration of the DL-PRS. Then, gNB performs channel access before the candidate COT the DL-PRS resource transmission time belonging to. One or more of the following channel access procedures can be applied before the candidate COT:
gNB senses at least one sensing slot immediately before the candidate COT, where a sensing slot is 9 microseconds. If at least one sensing slot is sensed to be idle, the candidate COT can be initiated for DL-PRS transmission.
Alternatively, gNB senses at least a sensing interval immediately before the candidate COT, where the sensing interval is 25 microseconds. The sensing interval includes two sensing slot, where a sensing slot is 9 microseconds, and where one sensing slot is at the start of the sensing interval and the other sensing slot is at the end of the sensing interval. If both two sensing slots of the sensing interval are sensed to be idle, the candidate COT can be initiated for DL-PRS transmission.
Alternatively, gNB senses at least a sensing duration immediately before the candidate COT, where the sensing duration is 16 microseconds. The sensing duration includes one sensing slot, where a sensing slot is 9 microseconds and is at the end of the sensing duration. If the total of at least 5 microseconds in the sensing duration with at least of 4 microseconds occurring in the sensing slot is sensed to be idle, the candidate COT can be initiated for DL-PRS transmission.

If a candidate COT is initiated, a gNB can transmit DL-PRS starting at the beginning of the candidate COT. If a gNB does not transmit DL-PRS transmission at the start of the initiated candidate COT and the duration between the start of initiated candidate COT and DL-PRS transmission time is at most one sensing slot/16 microseconds, the gNB can transmit DL-PRS directly at the DL-PRS transmission time. If a gNB does not transmit DL-PRS transmission at the start of the initiated candidate COT and the duration between the start of initiated candidate COT and DL-PRS transmission time is larger than one sensing slot/16 microseconds, the gNB may need to sense at least one sensing slot immediately before DL-PRS transmission. If at least one sensing slot is sensed to be idle, gNB can transmit DL-PRS immediately after the sensing slot.

In an initiated candidate COT, a gNB can transmit multiple DL-PRS resource. If there is a gap between the current DL-PRS resource and the previous DL-PRS resource, Type 2 channel access procedure can be used for the current DL-PRS resource. Alternatively, if the gap between the current DL-PRS resource and the previous DL-PRS resource is at most a sensing slot/16 microseconds, the current DL-PRS resource can be transmitted directly without sensing. If the gap between the current DL-PRS resource and the previous DL-PRS resource is larger than a sensing slot/16 microseconds, gNB may need to sense at least one sensing slot immediately before the current DL-PRS resource. If at least one sensing slot is sensed to be idle, gNB can transmit the current DL-PRS immediately after the sensing slot. Alternatively, a gNB can transmit multiple DL-PRS resource during an initiated candidate COT without sensing.

The initiated candidate COT can be shared by the initiating gNB to other gNBs to transmit DL-PRS. Other gNB can share the candidate COT for DL-PRS transmission based on Type 2 channel access procedure. Alternatively, other gNB can share the candidate COT for DL-PRS transmission based on implementation example 8 and implementation example 9.

For a DL-PRS resource, gNB can initiate one or more candidate channel occupancy starting at the first candidate COT. If the candidate channel occupancy is fail, the next candidate COT can be initiated. A gNB stops performing channel access procedure for the leftover candidate COTs, until one or more candidate COT is initiated successfully. Alternatively, gNB can initiate one or more candidate channel occupancy starting at the candidate COT the DL-PRS transmission time belonging to. If the candidate channel occupancy is fail, the next candidate COT can be initiated. A gNB stops perform channel access procedure for the leftover candidate COTs, until one or more candidate COT(s) is initiated successfully or the number of candidate COTs initiated is up to the maximum number of the candidate COTs. The number of candidate COT, which needs to be successfully initiated by gNB, can be determined by gNB.

Alternatively, within a DL-PRS transmission gap, a gNB can initiate channel occupancy based on Type 1 channel access procedure. The maximum number of the candidate COT initiated using Type 1 channel access procedure can be determined/configured by gNB, where the total duration time of all candidate COTs can not be larger than the length of DL-PRS transmission gap. For a DL-PRS resource transmission, a gNB can initiate a candidate COT based on Type 1 channel access procedure using CAPC value corresponding to the DL-PRS resource transmission. If the candidate channel occupancy is fail, the next candidate COT can be initiated based on Type 1 channel access procedure using CAPC value corresponding to the DL-PRS resource transmission. The gNB can stop performing channel access procedure for the leftover candidate COTs using CAPC value corresponding to the DL-PRS resource transmission, until one or more candidate COT(s) is initiated successfully or the number of candidate COTs initiated is up to the maximum number of the candidate COTs. The number of candidate COT, which needs to be successfully initiated by gNB, can be determined by gNB. If the time gap between two DL-PRS resources is at most one sensing slot/16 microseconds, a gNB can initiate COT to transmit the first DL-PRS resource, and can directly transmit the next DL-PRS resource without sensing. If the time gap between two DL-PRS resources is larger than one sensing slot/16 microseconds, a gNB needs to initiate a COT for the second DL-PRS resource based on Type 1 channel access procedure using CAPC value corresponding to the second DL-PRS resource transmission. Alternatively, if the time gap between two DL-PRS resources is larger than one sensing slot/16 microseconds, and if a gNB has initiated a COT for the first DL-PRS resource, the gNB can sense at least one sensing slot immediately before the second DL-PRS resource.

Alternatively, the configuration of each DL-PRS transmission gap can further include the repetition information of the DL-PRS transmission gap. The repetition information of the DL-PRS transmission gap at least includes: repetition factor and time gap between two repetitions of the DL-PRS transmission gap. FIG. 11 shows an illustration on DL-PRS transmission gap with multiple repetitions. In a repetition of a DL-PRS transmission gap, one or more COT(s) can be initiated to transmit DL-PRS resource using Type 1/2 channel access procedure. For a DL-PRS transmission, a gNB can initiate COT(s) beginning from the first repetition of a DL-PRS transmission gap. If the COT(s) initiating in the first repetition of the DL-PRS transmission gap is fail, the gNB can initiate the COT(s) in the next repetition of a DL-PRS transmission gap, until one or more COT(s)/repetition(s) is occupied successfully or the number of the repetitions initiating COT(s) is up to the maximum number of the repetitions of the DL-PRS transmission gap. Alternatively, for a DL-PRS resource, a gNB can determine which repetition of a DL-PRS transmission gap the DL-PRS resource transmission time belongs to based on the configuration of the DL-PRS. Then, the gNB initiates COT(s) for DL-PRS resource transmission within the repetition of a DL-PRS transmission gap the DL-PRS resource transmission time belonging to. FIG. 11 provides an illustration on DL-PRS transmission gap with repetitions.

### Implementation Example 12: Configuration of Positioning SRS Transmission Gap

Similar to DL-PRS transmission gap, a UE can configure the positioning SRS transmission gap, which is dedicated for positioning SRS transmission, receiving and measuring. For positioning SRS transmission/receiving/measuring, one or more positioning SRS transmission gap can be configured/activated/determined by LMF/higher layer of gNB/UE, e.g., gNB's RRC, gNB's MAC CE. Each positioning SRS transmission gap is associated with a positioning SRS transmission gap ID. The configuration of each positioning SRS transmission gap at least may include the following:
Positioning SRS transmission gap ID;
Length of positioning SRS transmission gap;
Period of positioning SRS transmission gap;
The reference point in time domain, e.g., SFN0, DFN0; and
Offset of positioning SRS transmission gap relative to the reference point in time domain.

In the positioning SRS transmission gap, a UE can perform channel access procedure before each positioning SRS resource transmission and initiate channel occupancy for every positioning SRS resource transmission. That is, the channel access procedure can be performed by UE per positioning SRS resource. One or more of the following channel access procedures can be applied to the channel occupancy initiation for positioning SRS resource transmission:
A UE senses at least one sensing slot immediately before positioning SRS resource transmission, where a sensing slot is 9 microseconds. If at least one sensing slot is sensed to be idle, UE transmits positioning SRS resource immediately following the sensing slot.
Alternatively, a UE senses at least a sensing interval immediately before positioning SRS resource transmission, where the sensing interval is 25 microseconds. The sensing interval includes two sensing slot, where a sensing slot is 9 microseconds, and where one sensing slot is at the start of the sensing interval and the other sensing slot is at the end of the sensing interval. If both two sensing slots of the sensing interval are sensed to be idle, UE transmits positioning SRS resource immediately following the sensing interval.
Alternatively, a UE senses at least a sensing duration immediately before positioning SRS resource transmission, where the sensing duration is 16 microseconds. The sensing duration includes one sensing slot, where a sensing slot is 9 microseconds and is at the end of the sensing duration. If the total of at least 5 microseconds in the sensing duration with at least of 4 microseconds occurring in the sensing slot is sensed to be idle, UE transmits positioning SRS resource immediately following the sensing duration.
Alternatively, a UE can initiate a COT for positioning SRS resource transmission based on Type 1 channel access procedure using CAPC value corresponding to the positioning SRS resource.

If the gap between two positioning SRS resource is less than one sensing slot/16 microseconds, the UE can initiate the channel occupancy for the first positioning SRS resource and directly transmit the next positioning SRS resource without sensing. However, if channel access operation is performed before every positioning SRS resource transmission, the UE needs to sense frequently and the failure probability of channel occupancy is large. To reduce the number of channel access operation and improve the success probability of channel occupancy, a UE can configure multiple candidate COTs for positioning SRS transmission in each positioning SRS transmission gap. Thus, in addition to the configuration of each positioning SRS transmission gap described above, the configuration of positioning SRS transmission gap can further include number of candidate COTs and the configuration of the candidate COTs. The candidate COTs can be configured by LMF/higher layer of gNB/UE, e.g., gNB's RRC, gNB's MAC CE. The candidate COT in a positioning SRS transmission gap can be periodic or aperiodic.

If the candidate COT in a positioning SRS transmission gap is periodic, the configuration of the candidate COT at least includes the following:
The candidate COT ID;
Length of the candidate COT;
Period of the candidate COT; and
Offset of the first candidate COT relative to the start time of the positioning SRS transmission gap.

If the candidate COT in a positioning SRS transmission gap is aperiodic, the configuration of the candidate COT at least includes the following:
The candidate COT ID;
Length of the candidate COT; and
Offset of the candidate COT relative to the start time of the positioning SRS transmission gap.

The candidate COT can be configured per positioning SRS transmission gap. That is, for different v transmission gaps, the configuration of the candidate COTs is different. Alternatively, the candidate COT can be configured per TRP. That is, the candidate COT can be configured to be the same if the positioning SRS transmission intends to be received and measured by the same gNB. Alternatively, the candidate COT can be configured per UE. That is, the candidate COT can configured to be different for different UEs.

For a positioning SRS resource, a UE may determine which candidate COT the positioning SRS resource transmission time belongs to based on the configuration of the positioning SRS. Then, UE performs channel access before the candidate COT the positioning SRS resource transmission time belonging to. One or more of the following channel access procedures can be applied before the candidate COT:
A UE senses at least one sensing slot immediately before positioning SRS resource transmission, where a sensing slot is 9 microseconds. If at least one sensing slot is sensed to be idle, the UE may transmit positioning SRS resource immediately following the sensing slot.
Alternatively, a UE senses at least a sensing interval immediately before positioning SRS resource transmission, where the sensing interval is 25 microseconds. The sensing interval includes two sensing slot, where a sensing slot is 9 microseconds, and where one sensing slot is at the start of the sensing interval and the other sensing slot is at the end of the sensing interval. If both two sensing slots of the sensing interval are sensed to be idle, UE transmits positioning SRS resource immediately following the sensing interval.
Alternatively, a UE senses at least a sensing duration immediately before positioning SRS resource transmission, where the sensing duration is 16 microseconds. The sensing duration includes one sensing slot, where a sensing slot is 9 microseconds and is at the end of the sensing duration. If the total of at least 5 microseconds in the sensing duration with at least of 4 microseconds occurring in the sensing slot is sensed to be idle, UE transmits positioning SRS resource immediately following the sensing duration.

If a candidate COT is initiated, a UE can transmit positioning SRS starting at the beginning of the candidate COT. If a UE does not transmit positioning SRS transmission at the start of the initiated candidate COT and the duration between the start of initiated candidate COT and positioning SRS transmission time is at most one sensing slot/16 microseconds, the UE can transmit positioning SRS directly at the positioning SRS transmission time. If a UE does not transmit positioning SRS transmission at the start of the initiated candidate COT and the duration between the start of initiated candidate COT and positioning SRS transmission time is larger than one sensing slot/16 microseconds, the UE needs to sense at least one sensing slot immediately before positioning SRS transmission. If at least one sensing slot is sensed to be idle, UE can transmit positioning SRS immediately after the sensing slot.

In an initiated candidate COT, a UE can transmit multiple positioning SRS resource. If there is a gap between the current positioning SRS resource and the previous positioning SRS resource, Type 2 channel access procedure can be used for the current positioning SRS resource. Alternatively, if the gap between the current positioning SRS resource and the previous positioning SRS resource is at most a sensing slot/16 microseconds, the current positioning SRS resource can be transmitted directly without sensing. If the gap between the current positioning SRS resource and the previous positioning SRS resource is larger than a sensing slot/16 microseconds, the UE may need to sense at least one sensing slot immediately before the current positioning SRS resource. If at least one sensing slot is sensed to be idle, UE can transmit the current positioning SRS immediately after the sensing slot. Alternatively, a UE can transmit multiple positioning SRS resource during an initiated candidate COT without sensing.

For a positioning SRS resource, a UE can initiate one or more candidate channel occupancy starting at the first candidate COT. If the candidate channel occupancy is fail, the next candidate COT can be initiated. A UE stops performing channel access procedure for the leftover candidate COTs, until one or more candidate COT is initiated successfully. Alternatively, UE can initiate one or more candidate channel occupancy starting at the candidate COT the positioning SRS transmission time belonging to. If the candidate channel occupancy is fail, the next candidate COT can be initiated. A UE stops perform channel access procedure for the leftover candidate COTs, until one or more candidate COT(s) is initiated successfully or the number of candidate COTs initiated is up to the maximum number of the candidate COTs. The number of candidate COT, which needs to be successfully initiated by UE, can be determined by UE.

Alternatively, within a positioning SRS transmission gap, a UE can initiate channel occupancy based on Type 1 channel access procedure. The maximum number of the candidate COT initiated using Type 1 channel access procedure can be determined/configured by LMF/gNB/UE, where the total duration time of all candidate COTs can not be larger than the length of positioning SRS transmission gap. For a positioning SRS resource transmission, a UE can initiate a candidate COT based on Type 1 channel access procedure using CAPC value corresponding to the positioning SRS resource transmission. If the candidate channel occupancy is fail, the next candidate COT can be initiated based on Type 1 channel access procedure using CAPC value corresponding to the positioning SRS resource transmission. The UE can stop performing channel access procedure for the leftover candidate COTs using CAPC value corresponding to the positioning SRS resource transmission, until one or more candidate COT(s) is initiated successfully or the number of candidate COTs initiated is up to the maximum number of the candidate COTs. The number of candidate COT, which needs to be successfully initiated by UE, can be determined by UE. If the time gap between two positioning SRS resources is at most one sensing slot/16 microseconds, a UE can initiate COT to transmit the first positioning SRS resource, and can directly transmit the next positioning SRS resource without sensing. If the time gap between two positioning SRS resources is larger than one sensing slot/16 microseconds, a UE may need to initiate a COT for the second positioning SRS resource based on Type 1 channel access procedure using CAPC value corresponding to the second positioning SRS resource transmission. Alternatively, if the time gap between two positioning SRS resources is larger than one sensing slot/16 microseconds, and if a UE has initiated a COT for the first positioning SRS resource, the UE can sense at least one sensing slot immediately before the second positioning SRS resource.

Alternatively, the configuration of each positioning SRS transmission gap can further include the repetition information of the positioning SRS transmission gap. The repetition information of the positioning SRS transmission gap at least includes: repetition factor and time gap between two repetitions of the positioning SRS transmission gap. In a repetition of a positioning SRS transmission gap, one or more COT(s) can be initiated to transmit positioning SRS resource using Type 1/2 channel access procedure. For a positioning SRS transmission, a UE can initiate COT(s) beginning from the first repetition of a positioning SRS transmission gap. If the COT(s) initiating in the first repetition of the positioning SRS transmission gap is fail, the UE can initiate the COT(s) in the next repetition of a positioning SRS transmission gap, until one or more COT(s)/repetition(s) is occupied successfully or the number of the repetitions initiating COT(s) is up to the maximum number of the repetitions of the positioning SRS transmission gap. Alternatively, for a positioning SRS resource, a UE can determine which repetition of a positioning SRS transmission gap the positioning SRS resource transmission time belongs to based on the configuration of the positioning SRS. Then, the UE initiates COT(s) for positioning SRS resource transmission within the repetition of a positioning SRS transmission gap the positioning SRS resource transmission time belonging to.

### Implementation Example 13: DL-PRS Transmission in Multiple Channels

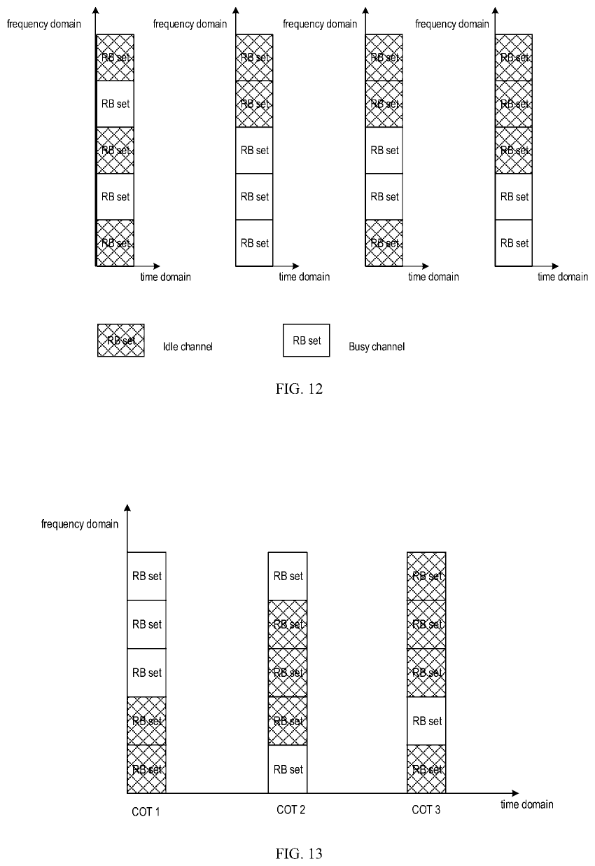

To obtain the satisfied positioning accuracy, bandwidth of DL-PRS is usually large. In unlicensed band, DL-PRS transmission may need multiple channels. Since the channel access operation is performed per channel, some channels may be accessed successfully, while some channels may be not accessed. FIG. 12 shows an illustration on multiple channel access. Thus, how to transmit DL-PRS in multiple channels in unlicensed band is a problem. In this implementation example, some configuration and rules are provided for DL-PRS transmission in multiple channels. FIG. 12 provides an illustration on multiple channel access.

If some channels are accessed successfully and some channels are not accessed, the gNB may transmit DL-PRS in the accessed channels when some conditions are satisfied. LMF can configure channel patterns. When the pattern of accessed channels satisfies the channel pattern configured by LMF, DL-PRS can be transmitted in the accessed channels. To reduce the detection complexity, the UE can detect DL-PRS in frequency domain according to the channel patterns configured by the LMF.

Rules gNB may need to be satisfied for DL-PRS transmission in multiple channels can be at least one or more of the following:
If the successfully accessed channels are continuous and the number of continuous accessed channels is not less than a threshold, the gNB can transmit DL-PRS in the contiguous accessed channels. Otherwise, gNB may not transmit DL-PRS in any channels. The threshold can be configured/determined by LMF/gNB.
When one certain channel is guaranteed to be accessed successfully and there are several channels continuous with the certain channel are accessed successfully, the gNB can transmit DL-PRS in the certain channel and its continuously accessed channels, if the total number of the certain channel and its continuously accessed channels is not less than a threshold. Otherwise, gNB does not transmit DL-PRS in any channels. The certain channel and the threshold can be configured/determined by the LMF/gNB. The certain channel can be associated with one or more: a RB set ID, the start location of RB set in frequency domain, or bandwidth of RB set.

If the number of successfully accessed channels is not less than a threshold, gNB can transmit DL-PRS in the accessed channels. Otherwise, gNB does not transmit DL-PRS in any channels. The threshold can be configured/determined by LMF/gNB.

The solutions described above can be applied to DL-PRS transmission in multiple channels with guard band or without guard band. The serving gNB can transmit the information of accessed channels for DL-PRS transmission to UE by Downlink Control Information (DCI). Alternatively, the serving gNB can transmit the information of accessed channels for DL-PRS transmission to LMF via NRPPa, and LMF can transmit the information of these accessed channels to UE via LPP. The information of accessed channels on which DL-PRS is transmitted at least includes one or more: IDs of RB sets, the start locations of RB sets in frequency domain, or bandwidth of RB sets.

Furthermore, the serving gNB may transmit the information of channels for DL-PRS transmission of neighbouring gNBs to UE by DCI. Alternatively, the serving gNB may transmit the information of channels for DL-PRS transmission of neighbouring gNBs to LMF by NRPPa, and LMF transmits the information of channels for DL-PRS transmission of neighbouring gNBs to UE by LPP.

For positioning SRS transmission, bandwidth of positioning SRS is also large. In unlicensed band, positioning SRS transmission often needs multiple channels. Since the channel access operation is performed per channel, some channels may be accessed successfully, while some channels may be not accessed. The solutions for positioning SRS transmission in multiple channels are similar to DL-PRS transmission in multiple channels.

If some channels are accessed successfully and some channels are not accessed, UE may transmit DL-PRS in the accessed channels when some conditions are satisfied. LMF can configure channel patterns. When the pattern of accessed channels satisfies the channel pattern configured by LMF, positioning SRS can be transmitted in the accessed channels. LMF can transmit the channel patterns to gNB, gNB can detect positioning SRS in frequency domain according to the channel patterns configured by LMF.

Rules UE may need to be satisfied for positioning SRS transmission in multiple channels can be at least one or more of the following:
If the successfully accessed channels are continuous and the number of continuous accessed channels is not less than a threshold, the UE can transmit positioning SRS in the contiguous accessed channels. Otherwise, the UE may not transmit positioning SRS in any channels. The threshold can be configured/determined by LMF/gNB/UE.
When one certain channel is guaranteed to be accessed successfully and there are several channels continuous with the certain channel are accessed successfully, the UE can transmit positioning SRS in the certain channel and its continuously accessed channels, if the total number of the certain channel and its continuously accessed channels is not less than a threshold. Otherwise, the UE may not transmit positioning SRS in any channels. The certain channel and the threshold can be configured/determined by LMF/gNB/UE. The certain channel can be associated with one or more: a RB set ID, the start location of RB set in frequency domain, or bandwidth of RB set.

The solutions for positioning SRS transmission in multiple channels can be applied to multiple channels with guard band or without guard band. A UE can transmit the information of accessed channels for positioning SRS transmission to its serving gNB by UCI. And a UE can transmit the information of accessed channels for positioning SRS transmission to LMF via LPP, and LMF can transmit the information of these accessed channels to neighboring gNBs via NRPPa. The information of accessed channels on which DL-PRS is transmitted at least includes one or more: IDs of RB sets, the start locations of RB sets in frequency domain and bandwidth of RB sets. Alternatively, a UE can transmit the information of accessed channels for positioning SRS transmission to LMF via LPP, and LMF can transmit the information of these accessed channels to the serving gNB and neighboring gNBs via NRPPa.

### Implementation Example 14: DL-PRS Transmission of Multiple gNBs in Multiple Channels

In implementation example #11, the rules and configuration are provided for DL-PRS transmission in multiple channels. If a gNB accesses multiple channels satisfying DL-PRS transmission condition, it can share these multiple accessed channels to other gNBs. Multiple gNBs can transmit DL-PRS with comb-based multiplexing in a channel. Thus, the gNB initiating COT in multiple channels can tell the accessed channel information and its DL-PRS configuration to other gNBs via:
Xn interface.
Alternatively, LMF by NRPPa. That is, the initiating gNB transmits the accessed channel information to LMF via NRPPa, and then LMF transmits the accessed channel information and DL-PRS configuration of the initiating gNB to other gNBs via NRPPa.

The accessed channel information and DL-PRS configuration of the initiating gNB include one or more of the following:
IDs of accessed RB sets;
The start locations of accessed RB sets in frequency domain;
Bandwidth of each of accessed RB sets;
Comb size of DL-PRS resource of the initiating gNB; or
Comb offset of DL-PRS resource of the initiating gNB.

### Implementation Example 15: Frequency Hopping for DL-PRS/Positioning SRS Transmission in Inter-COT

In unlicensed band, DL-PRS/positioning SRS may be transmitted in multiple channels. Since some channels may be available while some channels may be not available, DL-PRS/positioning SRS resource may be transmitted incompletely and the bandwidth in a COT for DL-PRS/positioning SRS transmission is not satisfying. To solve this problem, DL-PRS/positioning SRS frequency hopping in inter-COT is introduced in this implementation example.

For DL-PRS/positioning SRS transmission purpose, after a gNB/UE performs channel occupancy procedure in multiple channels for a COT, the gNB/UE can transmit the channel occupancy information for DL-PRS/positioning SRS resource to LMF via NRPPa/LPP. The channel occupancy information for DL-PRS/positioning SRS resource in a COT at least includes one or more of the following:
COT ID;
Length of COT;
The start time of COT;
IDs of RB sets occupied for DL-PRS/positioning SRS resource within the COT;
The start locations of RB sets within the COT in frequency domain; or
Bandwidth of each of RB sets within the COT.

FIG. 13 shows the channel occupancy in multiple RB sets in multiple COTs. LMF determines whether frequency hopping in inter-COT is performed for DL-PRS/positioning SRS receiving. An indicator can be configured by LMF, and transmitted to UE/gNB via LPP/NRPPa. The indicator indicates whether UE/gNB receives DL-PRS/positioning SRS with frequency hopping in inter-COT, which is 1 bit. The indicator for DL-PRS frequency hopping can be provided by LMF to UE in assistance data. To assist UE/gNB to receive DL-PRS/positioning SRS and perform frequency hopping, LMF can provide the information of COTs on which frequency hopping is performed by the UE/gNB. The information of a COT at least includes one or more of the following:
COT ID;
Length of COT;
The start time of COT;
IDs of RB sets occupied for DL-PRS/positioning SRS within the COT;
The start location of RB sets occupied for DL-PRS/positioning SRS within the COT in frequency domain; or
Bandwidth of each of RB sets occupied for DL-PRS/positioning SRS.

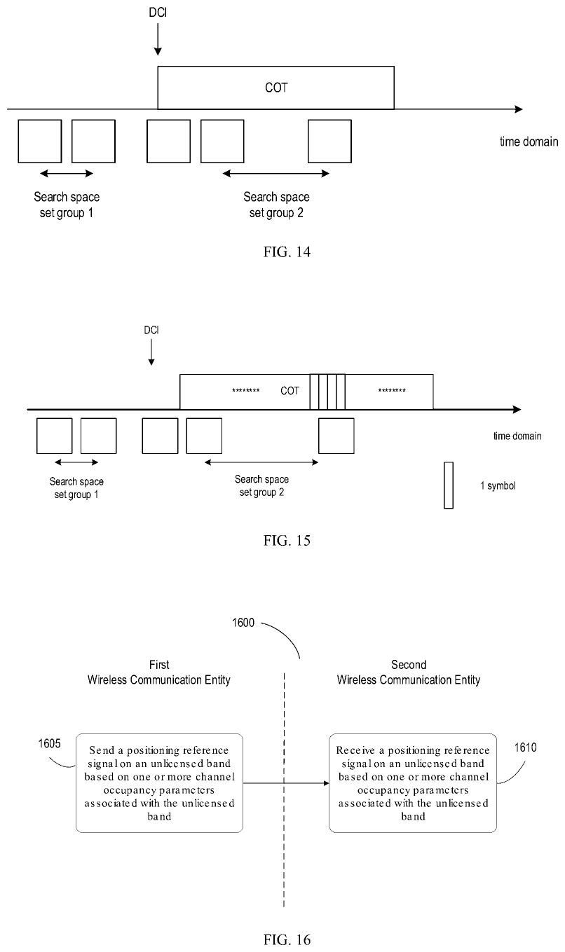

When a UE/gNB receives the frequency hopping indicator and COTs information, the UE/gNB can measure DL-PRS/positioning SRS and obtain the measurement based on multiple hops of DL-PRS/positioning SRS in these multiple COTs and corresponding RB sets, if the indicator indicate the frequency hopping is performed. FIG. 14 illustrates a channel occupancy in multiple RB sets in multiple COTs.

### Implementation Example 16: DL-PRS Reception by UE

If Type 1 channel access procedure is used by a gNB to initiate a channel occupancy for DL-PRS transmission, the sensing duration for accessing channel is random, and then DL-PRS transmission time is random. How to receive and measure DL-PRS in unlicensed band is a problem. One solution is that UE continuously detects DL-PRS. However, the power consumption is large if UE continuously detects DL-PRS. In this Embodiment, two search space set groups are introduced for DL-PRS reception.

For DL-PRS reception, two search space set group can be configured by LMF/gNB's higher layer. A UE can detect DCI outside of the COT in one search space set group, and can detect DL-PRS within the COT in another search space set group. The search frequency is different for two search space set groups. The search space set group switching is indicated by DCI. DCI includes at least: the COT duration and the search space set group switching indicator. A UE may detect DCI using one search space set group, and switches to another search space set group to detect DL-PRS within the COT duration when the UE detects DCI. The starting time of the COT is the slot in which DCI is detected. The search space set group for searching DL-PRS within the COT is associated with the period of DL-PRS resource. If there are multiple DL-PRS resource within the COT, the search space set group for searching DL-PRS within the COT is related to the common factor of the periods of multiple DL-PRS resources. FIG. 14 shows a UE detects DCI and DL-PRS with two search space set groups. Alternatively, LMF/gNB's higher layer can configure one search space set group for DL-PRS reception. This search space set group is used to detect DCI outside of the COT. DCI includes at least the COT duration. When a UE detects DCI, the UE continuously detects DL-PRS within the COT. FIG. 14 illustrates UE reception with two search space set groups.

If a gNB transmits DL-PRS transmission not including DCI, a search window can be configured/preconfigured by LMF/gNB's higher layer. The search window can be period or a period. If the search window is period, the configuration of the search window includes at least one or more of the following:
Length of the search window;
Period of the search window;
The start time of the first period of the search window/the offset of the first period of the search window relative to the reference time; or
The reference time, e.g., SFN0/DFN0.

If the search window is period, the configuration of the search window may include at least one or more of the following:
Length of the search window;
The start time of the search window/the offset of the search window relative to the reference time; or
The reference time, e.g., SFN0/DFN0.

If a gNB transmits DL-PRS transmission not including DCI, a UE considers that the gNB initiates one or more COT(s) within the search window and DL-PRS is transmitted within the search window. Thus, a UE can receive DL-PRS in a search space set group outside of the search window, and can receive DL-PRS in another search space set group within the search window. The search space set groups can be configured by LMF/gNB's higher layer. The search space set group used to receive DL-PRS within the search window is associated with the period of DL-PRS resource. If there are multiple DL-PRS resource within the search window, the search space set group for receiving DL-PRS within the search window is related to the common factor of the periods of multiple DL-PRS resources. Alternatively, a UE can receive DL-PRS in a search space set group only within the search window, and not detect and receive DL-PRS outside of the search window. The search space set group can be configured by LMF/gNB's higher layer. Alternatively, a UE can continuously receive DL-PRS within the search window, and not detect and receive DL-PRS outside of the search window.

If a UE does not receive the first symbol of DL-PRS resource, the UE may not receive other symbols of this DL-PRS resource anymore. Alternatively, if the number of DL-PRS resource symbols not received by a UE is larger than or equal to a threshold, the UE may not receive other symbols of this DL-PRS resource anymore. The threshold can be configured by LMF/gNB's higher layer. The threshold can be related to the number of symbols of DL-PRS resource and comb size of DL-PRS resource. FIG. 15 shows an illustration on DL-PRS reception, where some DL-PRS symbols are missed detection.

It should be understood that one or more features from the above implementation examples are not exclusive to the specific implementation examples, but can be combined in any manner (e.g., in any priority and/or order, concurrently or otherwise).

FIG. 16 illustrates a flow diagram of a method 1600 for transmission and reception of positioning reference signal in a new radio (NR) unlicensed band. The method 1600 may be implemented using any one or more of the components and devices detailed herein in conjunction with FIGS. 1-15. In overview, the method 1600 may be performed by a first wireless communication entity (e.g., a BS 202 or a UE 204) and/or a second wireless communication entity (e.g., a BS 202 or a UE 204), in some embodiments. Additional, fewer, or different operations may be performed in the method 1600 depending on the embodiment. At least one aspect of the operations is directed to a system, method, apparatus, or a computer-readable medium.

A first wireless communication entity may send a positioning reference signal on an unlicensed band based on one or more channel occupancy parameters associated with the unlicensed band to a second wireless communication entity. The first wireless communication entity may identify the one or more channel occupancy parameters based on reusing a Channel Access Priority Class (CAPC) table configured for data transmission.

In some embodiments, the first wireless communication entity may identify the one or more channel occupancy parameters based on a preconfigured CAPC table. A configuration of the preconfigured CAPC table is associated with a configuration of the positioning reference signal. The one or more channel occupancy parameters may include at least one of: a CAPC value, a minimum contention window size, a maximum contention window size, an allowed contention window size, or a maximum Channel Occupancy Time (COT).

In some embodiments, the configuration of the positioning reference signal, which is a DL-PRS, may include at least one of: a priority of the DL-PRS, a duration of transmission of the DL-PRS, a repetition factor of the DL-PRS, a time gap between two repetitions of the DL-PRS, or a period of the DL-PRS. The configuration of the positioning reference signal, which is an UL-SRS, may include at least one of: a priority of the UL-SRS, a duration of transmission of the UL-SRS, a number of symbols of the UL-SRS, or a period of the UL-SRS.

In some embodiments, the CAPC value can indicated by an Information Element (IE) explicitly. The CAPC value can be determined based on the configuration of the positioning reference signal. The CAPC value for sending the positioning reference signal, which is a DL-PRS, can be configured by a core network entity or a higher layer of the first wireless communication entity. The CAPC value for sending the positioning reference signal, which is a UL-SRS, can be configured by the core network entity or the higher layer of the first wireless communication entity or a higher layer of the second wireless communication entity.

In some embodiments, the CAPC value for sending the positioning reference signal, which is a DL-PRS, can be configured per Physical Frequency Layer (PFL), per DL-PRS resource set, or per DL-PRS resource. The CAPC value for sending the positioning reference signal, which is a UL-SRS, can be configured per Bandwidth Part (BWP), per UL-SRS resource set, or per UL-SRS resource. The second wireless communication entity can be in an RRC_CONNECTED state. The CAPC value for sending the positioning reference signal, which is a UL-SRS, can be configured per UL-SRS resource set or per UL-SRS resource, and wherein the second wireless communication entity is in an RRC_INACTIVE state.

In some embodiments, the first wireless communication entity may initiate a channel occupancy procedure using a Type 2A channel access procedure, upon at least one of the following conditions being satisfied: (a) a transmission duration of a DL-PRS is at most 1 ms and a transmission duty cycle of the DL-PRS is at most 1/20; (b) a CAPC value configured for the DL-PRS is less than or equal to a CAPC threshold; (c) a priority value configured for the DL-PRS is less than a priority threshold; or (d) transmission of the DL-PRS is broadcasted. The first wireless communication entity may send the positioning reference signal in a shared channel occupancy procedure, upon the following condition being satisfied: a CAPC value configured for the positioning reference signal is less than or equal to a CAPC value initiating the shared channel occupancy procedure.

In some embodiments, a period of the positioning reference signal can be associated with a period of a semi-static channel occupancy procedure. The association may include at least one of: the period of the positioning reference signal can be equal to the period of the semi-static channel occupancy procedure, or the period of the positioning reference signal can be an integer multiple of the period of semi-static occupancy procedure. A configuration of a semi-static channel occupancy procedure for the positioning reference signal may not be limited to a number of radio frames. The configuration of the semi-static channel occupancy procedure may include at least one of: a period of the semi-static channel occupancy procedure, or a time offset of the period of the semi-static channel occupancy procedure relative to a reference time.

In some embodiments, the first wireless communication entity may report information about a semi-static channel occupancy procedure initiated by the first wireless communication entity to a core network entity. The information may include at least one of: a period of the semi-static channel occupancy procedure, a time of idle duration, or a COT length. The core network entity may recommend a transmission resource of the positioning reference signal, which is a DL-PRS, to the first wireless communication entity. The core network entity may recommend a transmission resource of the positioning reference signal, which is an UL-SRS, to a serving base station.

In some embodiments, in response to determining that a time-domain resource configured for the positioning reference signal is within a COT, the first wireless communication entity may send the positioning reference signal. In response to determining that a time-domain resource configured for the positioning reference signal is not within a COT, the first wireless communication entity may stop sending the positioning reference signal.

In some embodiments, the first wireless communication entity may send the positioning reference signal based on some rules, if only partial symbols of configured for the positioning reference signal are within a COT. The first wireless communication entity may send channel occupancy window related information related to the positioning reference signal to a third wireless communication entity. The first wireless communication entity or the second wireless communication entity may be previously initiated a COT for the positioning reference signal. If the COT is initiated based on a dynamic channel access procedure, the channel occupancy window related information may include at least one of: a CAPC value initiating the COT, a duration of the COT, a start time of the COT, a length of a channel occupancy window, or a start time of the channel occupancy window.

In some embodiments, if the COT is initiated based on a semi-static channel occupancy, the channel occupancy window related information may include at least one of: a period of the semi-static channel occupancy, a maximum COT of a period of semi-static channel occupancy, a start time of a period of semi-static channel occupancy, a length of a channel occupancy window, or a start time of the channel occupancy window. The length of the channel occupancy window may not be larger than the maximum COT. The length of the channel occupancy window may not be larger than the maximum COT of a period of the semi-static channel occupancy. The third wireless communication entity can be determined by the first wireless communication entity or the second wireless communication entity or the core network entity.

In some embodiments, a PFL configured for sending the positioning reference signal may include an integer number of Resource Block (RB) sets. The first wireless communication entity may perform a channel access procedure per RB set. A guard band can be configured or not configured between two continuous RB sets. An indicator of multiple-channel access procedure type can be included in a configuration of the PFL, or a configuration of a positioning service, or a configuration of a positioning reference signal resource set, or a configuration of a positioning reference signal resource.

In some embodiments, one or more transmission gaps, configured for sending the positioning reference signal, which is a DL-PRS, can be configured by a higher layer of the first wireless communication entity. One or more transmission gaps, configured for sending the positioning reference signal, which is an UL-SRS, can be configured by a core network entity, a higher layer of the first wireless communication entity, or a higher layer of the second wireless communication entity. The one or more transmission gaps can be each associated with a transmission gap ID. A configuration of the one or more transmission gaps may include at least one of: a transmission gap ID, a length of the one or more transmission gaps, a period of the one or more transmission gaps, a reference point in a time domain, or an offset of the one or more transmission gaps relative to the reference point in the time domain.

In some embodiments, the first wireless communication entity may perform a channel access procedure before each positioning reference signal resource transmission in a transmission gap. If the positioning reference signal is a DL-PRS, multiple candidate COTs for sending the positioning reference signal can be configured by a higher layer of the first wireless communication entity in a transmission gap. If the positioning reference signal is an UL-SRS, multiple candidate COTs for sending the positioning reference signal can be configured by a core network entity, or a higher layer of the first wireless communication entity, or a higher layer of a serving base station in a transmission gap. A configuration of the transmission gap further may include number of candidate COTs and the configuration of the candidate COTs. The candidate COTs in the transmission gap can be periodic or aperiodic. If the candidate COTs are periodic, a configuration of one of the candidate COTs may include at least one of: an ID of the candidate COT, a length of the candidate COT, a period of the candidate COT, or an offset of the candidate COT relative to a start time of the transmission gap. If the candidate COTs are aperiodic, a configuration of one of the candidate COTs may include at least one of: an ID of the candidate COT, a length of the candidate COT, or an offset of the candidate COT relative to a start time of the transmission gap. The candidate COTs in the transmission gap for sending the positioning reference signal, which is a DL-PRS, can be configured per transmission gap, or per PFL, or per serving cell, or per UE. The candidate COTs in the transmission gap for sending the positioning reference signal, which is an UL-SRS, can be configured per transmission gap, or per UE, or per TRP.

In some embodiments, the first wireless communication entity may perform a channel access procedure per candidate COT. A configuration of the transmission gap may further include a maximum number of the candidate COTs initiated using a Type 1 channel access procedure. A total duration time of all of the candidate COTs initiated using the Type 1 channel access procedure may not be larger than the length of the transmission gap. A configuration of the transmission gap further includes repetition information of the transmission gap. The repetition information of the transmission gap may include at least one of: a repetition factor or a time gap between two repetitions of the transmission gap.

In some embodiments, the first wireless communication entity may send the positioning reference signal in multiple successfully accessed channels, upon the following condition being satisfied: the channels are continuous and a number of the continuous channels is not less than a threshold. The first wireless communication entity may send the positioning reference signal in a channel pattern, upon the following condition being satisfied: a successfully accessed channel corresponds to the channel pattern. The channel pattern can be configured by a core network entity. The second wireless communication entity may receive the positioning reference signal according to the channel pattern.

In some embodiments, a transmission of the positioning reference signal and a transmission of another positioning reference signal sent by another first wireless communication entity can be configured in a comb-based multiplexing manner. The first wireless communication entity may send accessed channel information and a configuration of the positioning reference signal to a third wireless communication entity. The accessed channel information may include at least one of: IDs of accessed RB sets, start locations of the accessed RB sets in a frequency domain, or a bandwidth of each of the accessed RB sets. The configuration of the positioning reference signal may include at least one of: a comb size of the positioning reference signal; or a comb offset of the positioning reference signal.

In some embodiments, the one or more channel occupancy parameters can be sent by the first or second communication entity to a core network entity. The one or more channel occupancy parameters may include at least one of: a ID of a COT; a length of the COT; a starting time of the COT; IDs of RB sets occupied for the positioning reference signal within the COT; start locations of the RB sets within the COT in a frequency domain; or a bandwidth of each of the RB sets within the COT.

In some embodiments, the second communication entity may receive the positioning reference signal, which is a DL-PRS, according to a reception configuration configured by a higher layer of the first communication entity or a core network entity. The reception configuration may include a first search space set group and a second search space set group corresponding to a COT. The first search space set group can be configured to detect DCI outside of the COT. The second search space set group can be configured to receive the DL-PRS within the COT. The second search space set group can be associated with a period of the positioning reference signal resource.

In some embodiments, the reception configuration may include a search window, where the search window is periodic or aperiodic. If the search window is periodic, a configuration of the search window may include at least one of: a length of the search window, a period of the search window, or a start time of a first period of the search window. If the search window is aperiodic, a configuration of the search window may include at least one of: a length of the search window, or a period of the search window. The reception configuration may include a search space set group corresponding to the search window. The search space set group can be configured to receive the DL-PRS within the search window. The second communication entity may receive the positioning reference signal, which is a DL-PRS, continuously within the search window.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
sending, by a first wireless communication entity to a second wireless communication entity, a positioning reference signal on an unlicensed band based on one or more channel occupancy parameters associated with the unlicensed band.

2. The wireless communication method of claim 1, further comprising:
identifying, by the first wireless communication entity, the one or more channel occupancy parameters based on reusing a Channel Access Priority Class (CAPC) table configured for data transmission.

3. The wireless communication method of claim 1, further comprising:
identifying, by the first wireless communication entity, the one or more channel occupancy parameters based on a preconfigured CAPC table;
wherein a configuration of the preconfigured CAPC table is associated with a configuration of the positioning reference signal.

4. The wireless communication method of claim 2, wherein the one or more channel occupancy parameters include at least one of: a CAPC value, a minimum contention window size, a maximum contention window size, an allowed contention window size, or a maximum Channel Occupancy Time (COT).

5. (canceled)

6. (canceled)

7. The wireless communication method of claim 4, wherein the CAPC value is indicated by an Information Element (IE) explicitly:
or, wherein the CAPC value is determined based on the configuration of the positioning reference signal;
or, wherein the CAPC value for sending the positioning reference signal, which is a DL-PRS, is configured by a core network entity or a higher layer of the first wireless communication entity,
or, wherein the CAPC value for sending the positioning reference signal, which is a UL-SRS, is configured by the core network entity or the higher layer of the first wireless communication entity or a higher layer of the second wireless communication entity;
or, wherein the CAPC value for sending the positioning reference signal, which is a DL-PRS, is configured per Physical Frequency Layer (PFL), per DL-PRS resource set, or per DL-PRS resource;
or, wherein the CAPC value for sending the positioning reference signal, which is a UL-SRS, is configured per Bandwidth Part (BWP), per UL-SRS resource set, or per UL-SRS resource, and wherein the second wireless communication entity is in an RRC_CONNECTED state;
or, wherein the CAPC value for sending the positioning reference signal, which is a UL-SRS, is configured per UL-SRS resource set or per UL-SRS resource, and wherein the second wireless communication entity is in an RRC_INACTIVE state.

8. (canceled)

9. (canceled)

10. (canceled)

11. (canceled)

12. (canceled)

13. The wireless communication method of claim 1, further comprising:
initiating, by the first wireless communication entity, a channel occupancy procedure using a Type 2A channel access procedure, upon at least one of the following conditions being satisfied:
(a) a transmission duration of a DL-PRS is at most 1 ms and a transmission duty cycle of the DL-PRS is at most 1/20;
(b) a CAPC value configured for the DL-PRS is less than or equal to a CAPC threshold;
(c) a priority value configured for the DL-PRS is less than a priority threshold; or
(d) transmission of the DL-PRS is broadcasted;
or, further comprising:
sending, by the first wireless communication entity, the positioning reference signal in a shared channel occupancy procedure, upon the following condition being satisfied:
a CAPC value configured for the positioning reference signal is less than or equal to a CAPC value initiating the shared channel occupancy procedure:
or, further comprising:
in response to determining that a time-domain resource configured for the positioning reference signal is within a COT, sending, by the first wireless communication entity, the positioning reference signal;
or, further comprising:
in response to determining that a time-domain resource configured for the positioning reference signal is not within a COT, stopping sending, by the first wireless communication entity, the positioning reference signal;
or, further comprising:
sending, by the first wireless communication entity, the positioning reference signal based on some rules, if only partial symbols of configured for the positioning reference signal are within a COT;
or, wherein one or more transmission gaps, configured for sending the positioning reference signal, which is a DL-PRS, are configured by a higher layer of the first wireless communication entity;
or, wherein one or more transmission gaps, configured for sending the positioning reference signal, which is an UL-SRS, are configured by a core network entity, a higher layer of the first wireless communication entity, or a higher layer of the second wireless communication entity;
or, further comprising:
performing, by the first wireless communication entity, a channel access procedure per candidate COT;
or, further comprising:
sending, by the first wireless communication entity, the positioning reference signal in multiple successfully accessed channels, upon the following condition being satisfied:
the channels are continuous and a number of the continuous channels is not less than a threshold;
or, wherein a transmission of the positioning reference signal and a transmission of another positioning reference signal sent by another first wireless communication entity are configured in a comb-based multiplexing manner;
or, further comprising:
sending, by the first wireless communication entity to a third wireless communication entity, accessed channel information and a configuration of the positioning reference signal;
wherein the accessed channel information includes at least one of: IDs of accessed RB sets, start locations of the accessed RB sets in a frequency domain, or a bandwidth of each of the accessed RB sets; and
wherein the configuration of the positioning reference signal includes at least one of: a comb size of the positioning reference signal; or a comb offset of the positioning reference signal;
or, wherein the one or more channel occupancy parameters are sent by the first or second communication entity to a core network entity.

14. (canceled)

15. (canceled)

16. (canceled)

17. (canceled)

18. (canceled)

19. The wireless communication method of claim 1, further comprising:
reporting, by the first wireless communication entity to a core network entity, information about a semi-static channel occupancy procedure initiated by the first wireless communication entity;
wherein the information includes at least one of: a period of the semi-static channel occupancy procedure, a time of idle duration, or a COT length.

20. The wireless communication method of claim 19,
receiving, by the first wireless communication entity, a message that includes a recommendation from the core network entity, of a transmission resource of the positioning reference signal, which is a DL-PRS.

21. (canceled)

22. (canceled)

23. (canceled)

24. The wireless communication method of claim 1, further comprising:
sending, by the first wireless communication entity to a third wireless communication entity, channel occupancy window related information related to the positioning reference signal;
wherein the first wireless communication entity or the second wireless communication entity previously initiated a COT for the positioning reference signal.

25. (canceled)

26. (canceled)

27. (canceled)

28. (canceled)

29. The wireless communication method of claim 24, wherein the third wireless communication entity is determined by the first wireless communication entity or the second wireless communication entity or the core network entity.

30. The wireless communication method of claim 1, wherein a PFL configured for sending the positioning reference signal includes an integer number of Resource Block (RB) sets.

31. (canceled)

32. (canceled)

33. (canceled)

34. (canceled)

35. (canceled)

36. (canceled)

37. (canceled)

38. The wireless communication method of claim 1, further comprising:
performing, by the first wireless communication entity, a channel access procedure before each positioning reference signal resource transmission in a transmission gap.

39. (canceled)

40. (canceled)

41. The wireless communication method of claim 38, wherein a configuration of the transmission gap further includes number of candidate COTs and the configuration of the candidate COTs.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. The wireless communication method of claim 1, further comprising:
sending, by the first wireless communication entity, the positioning reference signal in a channel pattern, upon the following condition being satisfied:
a successfully accessed channel corresponds to the channel pattern.

54. The wireless communication method of claim 53, wherein the channel pattern is configured by a core network entity:
or, wherein the second wireless communication entity receives the positioning reference signal according to the channel pattern.

55. (canceled)

56. (canceled)

57. (canceled)

58. (canceled)

59. (canceled)

60. The wireless communication method of claim 1, wherein the second communication entity receives the positioning reference signal, which is a DL-PRS, according to a reception configuration configured by a higher layer of the first communication entity or a core network entity.

61. The wireless communication method of claim 60, wherein the reception configuration includes a first search space set group and a second search space set group corresponding to a COT, wherein the first search space set group is configured to detect DCI outside of the COT, and the second search space set group is configured to receive the DL-PRS within the COT.

62. The wireless communication method of claim 61, wherein the second search space set group is associated with a period of the positioning reference signal resource.

63. (canceled)

64. (canceled)

65. (canceled)

66. The wireless communication method of claim 60, wherein the reception configuration includes a search space set group corresponding to the search window, wherein the search space set group is configured to receive the DL-PRS within the search window:
or, wherein the second wireless communication entity receives the positioning reference signal, which is a DL-PRS, continuously within the search window.

67. (canceled)

68. (canceled)

69. An apparatus comprising:
at least one processor configured to perform the following operations:
sending, by a first wireless communication entity to a second wireless communication entity, a positioning reference signal on an unlicensed band based on one or more channel occupancy parameters associated with the unlicensed band.
